(19) United States
(12) Patent Application Publication
(10) Pub. No.: US 2026/0136275 A1
(43) Pub. Date: May 14, 2026

(54) NETWORK-SPECIFIC SYSTEM INFORMATION DESIGNS AND SIGNALING

(71) Applicant: QUALCOMM Incorporated, San Diego, CA (US)

(72) Inventors: Umesh PHUYAL, San Diego, CA (US); Karl Georg HAMPEL, Jersey City, NJ (US); Naeem AKL, Bridgewater, NJ (US); Bharat SHRESTHA, San Diego, CA (US)

(21) Appl. No.: 18/946,296

(22) Filed: Nov. 13, 2024

(51) Int. Cl. H04W 48/18; H04W 48/08

(52) U.S. Cl. CPC H04W 48/18; H04W 48/08

(57) ABSTRACT

Methods, systems, and devices for wireless communications are described. According to techniques described herein, a network may broadcast a master information block, and one or more system information blocks (SIBs). Some of the SIBs may be public land mobile network (PLMN)-specific SIBs. A user equipment (UE) may monitor for system information, and may identify PLMN-specific SIBs that correspond to relevant PLMNs (for example, PLMNs supported by a current cell or candidate cell). The UE may avoid monitoring for and receiving PLMN-specific SIBs that are not relevant to the UE (for example, the UE may not receive and decode one or more SIBs carrying information for irrelevant PLMNs not supported by the UE).

### TECHNICAL FIELD

The following relates generally to wireless communications and, more specifically, to network-specific system information designs and signaling.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A network entity may broadcast system information, which may be received by one or more UEs. In some examples, a cell may support one or more public land mobile networks (PLMNs) associated with the network entity and the one or more UEs. The system information may include a large quantity of information for the one or more PLMNs supported by the cell. Increases in system information may result in increased signaling overhead. However, some system information associated with a subset of the PLMNs may be irrelevant to some of the one or more UEs that do not support the subset of the PLMNs served by the cell.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a user equipment (UE). The UE may include a processing system that includes processor circuitry and memory circuitry that stores code. The processing system may be configured to cause the UE to receive a master information block (MIB) indicating at least a set of system information blocks (SIBs), each SIB of the set of SIBs corresponding to a respective public land mobile network (PLMN) of a set of PLMNs supported by a first cell, receive at least a first SIB of the set of SIBs corresponding to a first PLMN of the set of PLMNs supported by the UE in accordance with receiving the MIB, and perform wireless communications via at least the first PLMN in accordance with the first SIB.

Another innovative aspect of the subject matter described in this disclosure can be implemented in a method for wireless communication by or at a UE is described. The method may include receiving a MIB indicating at least a set of SIBs each SIB of the set of SIBs corresponding to a respective PLMN of a set of PLMNs supported by a first cell, receiving at least a first SIB of the set of SIBs corresponding to a first PLMN of the set of PLMNs supported by the UE in accordance with receiving the MIB, and performing wireless communications via at least the first PLMN in accordance with the first SIB.

Another innovative aspect of the subject matter described in this disclosure can be implemented in a UE for wireless communications is described. The UE may include means for receiving a MIB indicating at least a set of SIBs, each SIB of the set of SIBs corresponding to a respective PLMN of a set of PLMNs supported by a first cell, means for receiving at least a first SIB of the set of SIBs corresponding to a first PLMN of the set of PLMNs supported by the UE in accordance with receiving the MIB, and means for performing wireless communications via at least the first PLMN in accordance with the first SIB.

Another innovative aspect of the subject matter described in this disclosure can be implemented in a non-transitory computer-readable medium storing code for wireless communication by or at a UE. The code may include instructions executable by a processing system to receive a MIB indicating at least a set of SIBs, each SIB of the set of SIBs corresponding to a respective PLMN of a set of PLMNs supported by a first cell, receive at least a first SIB of the set of SIBs corresponding to a first PLMN of the set of PLMNs supported by the UE in accordance with receiving the MIB, and perform wireless communications via at least the first PLMN in accordance with the first SIB.

In some examples of the method, UEs, and non-transitory computer-readable medium described herein, the first SIB includes a first PLMN identifier of the first PLMN, where receiving the first SIB of the set of SIBs may be in accordance with reading the first PLMN identifier.

Some examples of the method, UEs, and non-transitory computer-readable medium described herein may further include operations, features, means, or instructions for refraining from receiving at least a second SIB of the set of SIBs corresponding to a second PLMN in accordance with the first SIB including the first PLMN identifier, where the UE does not support the second PLMN.

In some examples of the method, UEs, and non-transitory computer-readable medium described herein, the MIB further includes a set of multiple PLMN identifiers corresponding to respective PLMNs of the set of PLMNs, each PLMN identifier of the set of multiple PLMN identifiers corresponding to a respective SIB of the set of SIBs in accordance with a mapping.

Some examples of the method, UEs, and non-transitory computer-readable medium described herein may further include operations, features, means, or instructions for receiving, in accordance with the MIB, a common SIB including a set of multiple PLMN identifiers corresponding to respective PLMNs of the set of PLMNs, each PLMN identifier of the set of multiple PLMN identifiers corresponding to a respective SIB of the set of SIBs in accordance with a mapping.

Another innovative aspect of the subject matter described in this disclosure can be implemented in a network entity. The network entity may include a processing system that includes processor circuitry and memory circuitry that stores code. The processing system may be configured to cause the wireless network entity to transmit a MIB indicating at least a set of SIBs, each SIB of the set of SIBs corresponding to a respective PLMN of a set of PLMNs supported by a first cell, transmit the set of SIBs, a first SIB of the set of SIBs corresponding to a first PLMN of the set of PLMNs supported by a UE in accordance with transmitting the MIB, and perform wireless communications via at least the first PLMN in accordance with the first SIB.

Another innovative aspect of the subject matter described in this disclosure can be implemented in a method for wireless communication by or at a network entity. The method may include transmitting a MIB indicating at least a set of SIBs, each SIB of the set of SIBs corresponding to a respective PLMN of a set of PLMNs supported by a first cell, transmitting the set of SIBs, a first SIB of the set of SIBs corresponding to a first PLMN of the set of PLMNs supported by a UE in accordance with transmitting the MIB, and performing wireless communications via at least the first PLMN in accordance with the first SIB.

Another innovative aspect of the subject matter described in this disclosure can be implemented in a network entity. The network entity may include means for transmitting a MIB indicating at least a set of SIBs, each SIB of the set of SIBs corresponding to a respective PLMN of a set of PLMNs supported by a first cell, means for transmitting the set of SIBs, a first SIB of the set of SIBs corresponding to a first PLMN of the set of PLMNs supported by a UE in accordance with transmitting the MIB, and means for performing wireless communications via at least the first PLMN in accordance with the first SIB.

Another innovative aspect of the subject matter described in this disclosure can be implemented in a non-transitory computer-readable medium storing code for wireless communication by or at a network entity. The code may include instructions executable by one or more processors to transmit a MIB indicating at least a set of SIBs, each SIB of the set of SIBs corresponding to a respective PLMN of a set of PLMNs supported by a first cell, transmit the set of SIBs, a first SIB of the set of SIBs corresponding to a first PLMN of the set of PLMNs supported by a UE in accordance with transmitting the MIB, and perform wireless communications via at least the first PLMN in accordance with the first SIB.

In some examples of the method, network entities, and non-transitory computer-readable medium described herein, the first SIB includes a first PLMN identifier of the first PLMN, and a second SIB of the set of SIBs includes a second PLMN identifier of a second PLMN.

In some examples of the method, network entities, and non-transitory computer-readable medium described herein, the MIB further includes a set of multiple PLMN identifiers corresponding to respective PLMNs of the set of PLMNs, each PLMN identifier of the set of multiple PLMN identifiers mapped to a respective SIB of the set of SIBs.

Some examples of the method, network entities, and non-transitory computer-readable medium described herein may further include operations, features, means, or instructions for transmitting, in accordance with the MIB, a common SIB including a set of multiple PLMN identifiers corresponding to respective PLMNs of the set of PLMNs, each PLMN identifier of the set of multiple PLMN identifiers mapped to a respective SIB of the set of SIBs.

In some examples of the method, network entities, and non-transitory computer-readable medium described herein, the first SIB may be a first common SIB, and where the first common SIB includes an indication of one or more additional SIBs corresponding to the first PLMN, and a list of PLMN identifiers corresponding to the set of PLMNs, and where a second common SIB includes an indication of one or more additional SIBs corresponding to a second PLMN, and the list of PLMN identifiers corresponding to the set of PLMNs.

Some examples of the method, network entities, and non-transitory computer-readable medium described herein may further include operations, features, means, or instructions for transmitting an indication of a first type of system information corresponding to at least one PLMN of the set of PLMNs, and of a second type of system information corresponding to a second set of PLMNs, where the second set of PLMNs do not correspond to the set of SIBs.

Some examples of the method, network entities, and non-transitory computer-readable medium described herein may further include operations, features, means, or instructions for transmitting an indication of a P-RNTI corresponding to the first PLMN and transmitting system information medication signaling for the first PLMN in accordance with the P-RNTI.

Some examples of the method, network entities, and non-transitory computer-readable medium described herein may further include operations, features, means, or instructions for receiving a request message including a first PLMN identifier corresponding to the first PLMN, the request message indicating a request for the first SIB that may be specific to the first PLMN, where transmitting the first SIB in accordance with receiving the request message.

Some examples of the method, network entities, and non-transitory computer-readable medium described herein may further include operations, features, means, or instructions for receiving, by a distributed unit (DU) of the network entity from a centralized unit (CU), an indication of the first SIB corresponding to the first PLMN, where transmitting the first SIB may be in accordance with receiving the indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports network-specific system information designs and signaling in accordance with one or more aspects of the present disclosure.

FIG. 2 shows an example of a wireless communications system that supports network-specific system information designs and signaling in accordance with one or more aspects of the present disclosure.

FIG. 3 shows an example of a system information scheme that supports network-specific system information designs and signaling in accordance with one or more aspects of the present disclosure.

FIG. 4 shows an example of a system information scheme that supports network-specific system information designs and signaling in accordance with one or more aspects of the present disclosure.

FIG. 5 shows an example of a system information scheme that supports network-specific system information designs and signaling in accordance with one or more aspects of the present disclosure.

FIG. 6 shows an example of a system information scheme that supports network-specific system information designs and signaling in accordance with one or more aspects of the present disclosure.

FIG. 7 shows an example of a system information scheme that supports network-specific system information designs and signaling in accordance with one or more aspects of the present disclosure.

FIG. 8 shows an example of a process flow that supports network-specific system information designs and signaling in accordance with one or more aspects of the present disclosure.

FIGS. 9 and 10 show block diagrams of devices that support network-specific system information designs and signaling in accordance with one or more aspects of the present disclosure.

FIG. 11 shows a block diagram of a communications manager that supports network-specific system information designs and signaling in accordance with one or more aspects of the present disclosure.

FIG. 12 shows a diagram of a system including a device that supports network-specific system information designs and signaling in accordance with one or more aspects of the present disclosure.

FIGS. 13 and 14 show block diagrams of devices that support network-specific system information designs and signaling in accordance with one or more aspects of the present disclosure.

FIG. 15 shows a block diagram of a communications manager that supports network-specific system information designs and signaling in accordance with one or more aspects of the present disclosure.

FIG. 16 shows a diagram of a system including a device that supports network-specific system information designs and signaling in accordance with one or more aspects of the present disclosure.

FIGS. 17 through 20 show flowcharts illustrating methods that support network-specific system information designs and signaling in accordance with one or more aspects of the present disclosure.

### DETAILED DESCRIPTION

Various aspects generally relate to efficiently communicating system information, and more specifically communicating network specific system information (for example, public land mobile network (PLMN) specific system information, non-public network (NPN)-specific system information). The network may broadcast multiple PLMN-specific system information blocks (SIBs). A user equipment (UE) may monitor for and receive system information, and identify PLMN-specific SIBs that correspond to relevant PLMNs (for example, PLMNs supported by a current cell or a candidate cell). The UE may avoid monitoring for and receiving PLMN-specific SIBs that are not relevant to the UE (for example, the UE may not receive nor decode one or more SIBs carrying information for irrelevant PLMNs not supported by the UE). In some examples, a common SIB (for example, a common SIB1) may include a list of PLMN identifiers (IDs) indicating PLMN-specific SIBs, and the common SIB may indicate scheduling information for multiple PLMN-specific SIBs (for example, each PLMN-specific SIB including PLMN-specific fields for one of the PLMN IDs). In some examples, a common SIB (for example, a common SIB1) may include implicit or explicit scheduling information for multiple PLMN-specific SIBs. Each PLMN-specific SIB may include a PLMN ID and system information for the indicated PLMN. In such examples, the UE may monitor for and receive the PLMN-specific SIBs to identify the PLMN ID relevant to the UE, and may stop monitoring for and decoding any additional PLMN-specific SIBs upon decoding the PLMN-specific SIB corresponding to the PLMN ID that is relevant to the UE. In some examples, the common SIB (for example, SIB1) may include common parameters corresponding to all PLMNs, and only unique PLMN-specific system information may be included in the PLMN-specific SIBs. In some examples, the network may broadcast a SIB (for example, SIB1) for each PLMN, and each SIB1 may include scheduling information for additional PLMN-specific SIBs for one PLMN and a complete list of PLMN IDs supported by the cell. A UE may receive a first SIB1 for a first PLMN and either utilize the PLMN-specific SIB1 to identity the additional PLMN-specific SIBs for the first PLMN (for example, if the PLMN is relevant to the UE), or the UE may determine that another SIB1 exists for a second PLMN based on the list of PLMN IDs in the first SIB1 (for example, the UE may then monitor for and receive the other relevant SIB1s for the second PLMN).

Particular aspects of the subject matter described in this disclosure may be implemented to realize one or more following potential advantages. The techniques employed by the described communication devices may provide benefits and enhancements, including more efficient utilization of system resources and more efficient conveyance of system information by broadcasting PLMN-specific SIBs that the UE can receive if relevant or ignore if irrelevant. For example, a UE may be able to detect one or more PLMN-specific SIBs for PLMNs that are relevant to the UE. The UE may be able to receive the relevant PLMN-specific SIBs, and ignore (for example, refrain from monitoring for, receiving, and/or decoding) irrelevant PLMN-specific SIBs. Because of the broadcast PLMN-specific SIBs, the UE may be able to identify and receive relevant system information for some PLMNs and in some cases perform cell switching procedures or other procedures based thereon, without unnecessarily expending power to receive and decode irrelevant system information for irrelevant PLMNs (for example, that the UE does not support). The UE identifying and decoding only relevant PLMN-specific SIBs may result in improved power conservation, increased battery life, and improved user experience. Described techniques further support efficient communication of PLMN-specific information via PLMN-specific SIBs, such that other larger SIBs including all relevant PLMN information are less necessary, resulting in more efficient use of available system resources and decreased signaling overhead through broadcasting smaller SIBs instead.

Aspects of the disclosure are initially described in the context of wireless communications systems. Aspects of the disclosure are further illustrated by and described with reference to wireless communications systems, system information schemes, and process flows. Aspects of the disclosure are further illustrated by and described with reference to apparatus diagrams, system diagrams, and flowcharts that relate to network-specific system information designs and signaling.

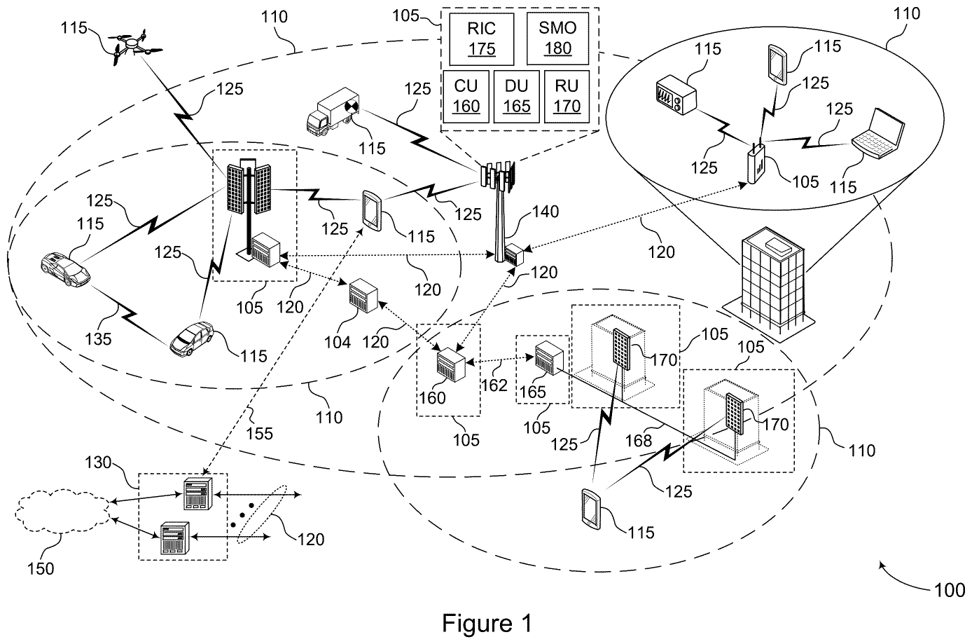

FIG. 1 shows an example of a wireless communications system 100 that supports network-specific system information designs and signaling in accordance with one or more aspects of the present disclosure. The wireless communications system 100 may include one or more devices, such as one or more network devices (for example, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (for example, a radio frequency (RF) access link). For example, a network entity 105 may support a coverage area 110 (for example, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (for example, other wireless communication devices, including UEs 115 or network entities 105), as shown in FIG. 1.

As described herein, a node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (for example, in accordance with an S1, N2, N3, or other interface protocol). In some examples, network entities 105 may communicate with one another via backhaul communication link(s) 120 (for example, in accordance with an X2, Xn, or other interface protocol) either directly (for example, directly between network entities 105) or indirectly (for example, via the core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication link(s) 120, midhaul communication links 162, or fronthaul communication links 168 may be or include one or more wired links (for example, an electrical link, an optical fiber link) or one or more wireless links (for example, a radio link, a wireless optical link), among other examples or various combinations thereof. A UE 115 may communicate with the core network 130 via a communication link 155.

One or more of the network entities 105 or network equipment described herein may include or may be referred to as a base station 140 (for example, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within one network entity (for example, a network entity 105 or a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among multiple network entities (for example, network entities 105), such as an integrated access and backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (for example, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more of the network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaptation protocol (SDAP), Packet Data Convergence Protocol (PDCP)). The CU 160 (for example, one or more CUs) may be connected to a DU 165 (for example, one or more DUs) or an RU 170 (for example, one or more RUs), or some combination thereof, and the DUs 165, RUs 170, or both may host lower protocol layers, such as layer 1 (L1 ) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or multiple different RUs, such as an RU 170). In some cases, a functional split between a CU 160 and a DU 165 or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (for example, F1, F1-c, F1-u), and a DU 165 may be connected to an RU 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities (for example, one or more of the network entities 105) that are in communication via such communication links.

In some wireless communications systems (for example, the wireless communications system 100), infrastructure and spectral resources for radio access may support wireless backhaul link capabilities to supplement wired backhaul connections, providing an IAB network architecture (for example, to a core network 130). In some cases, in an IAB network, one or more of the network entities 105 (for example, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (for example, IAB donors) may be in communication with one or more additional devices (for example, IAB node(s) 104) via supported access and backhaul links (for example, backhaul communication link(s) 120). IAB node(s) 104 may include an IAB mobile termination (IAB-MT) controlled (for example, scheduled) by one or more DUs (for example, DUs 165) of a coupled IAB donor. An IAB-MT may be equipped with an independent set of antennas for relay of communications with UEs 115 or may share the same antennas (for example, of an RU 170) of IAB node(s) 104 used for access via the DU 165 of the IAB node(s) 104 (for example, referred to as virtual IAB-MT (vIAB-MT)). In some examples, the IAB node(s) 104 may include one or more DUs (for example, DUs 165) that support communication links with additional entities (for example, IAB node(s) 104, UEs 115) within the relay chain or configuration of the access network (for example, downstream). In such cases, one or more components of the disaggregated RAN architecture (for example, the IAB node(s) 104 or components of the IAB node(s) 104) may be configured to operate according to the techniques described herein.

For instance, an access network (AN) or RAN may include communications between access nodes (for example, an IAB donor), IAB node(s) 104, and one or more UEs 115. The IAB donor may facilitate connection between the core network 130 and the AN (for example, via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (for example, a backhaul link). The IAB donor and IAB node(s) 104 may communicate via an F1 interface according to a protocol that defines signaling messages (for example, an F1 AP protocol). Additionally, or alternatively, the CU 160 may communicate with the core network 130 via an interface, which may be an example of a portion of a backhaul link, and may communicate with other CUs (for example, including a CU 160 associated with an alternative IAB donor) via an Xn-C interface, which may be an example of another portion of a backhaul link.

IAB node(s) 104 may refer to RAN nodes that provide IAB functionality (for example, access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (for example, an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (for example, the IAB node(s) 104) to receive signaling from a parent IAB node (for example, the IAB node(s) 104), and a DU interface (for example, a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (for example, backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (for example, transmissions to the UEs 115 relayed from the IAB donor) through one or more DUs (for example, DUs 165). That is, data may be relayed to and from IAB node(s) 104 via signaling via an NR Uu interface to MT of IAB node(s) 104 (for example, other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support network-specific system information designs and signaling as described herein. For example, some operations described as being performed by a UE 115 or a network entity 105 (for example, a base station 140) may additionally, or alternatively, be performed by one or more components of the disaggregated RAN architecture (for example, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (for example, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (for example, a bandwidth part (BWP)) that is operated according to one or more PHY layer channels for a given RAT (for example, LTE, LTE-A, LTE-A Pro, NR). Each PHY layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different RAT).

The communication link(s) 125 of the wireless communications system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communications (for example, in an FDD mode) or may be configured to carry downlink and uplink communications (for example, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (for example, 1.4, 3, 5, 10, 15, 20, 40, or 80 megahertz (MHz)). Devices of the wireless communications system 100 (for example, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ⋅N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to UEs 115 (for example, one or more UEs) or may include UE-specific search space sets for sending control information to a UE 115 (for example, a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (for example, using a carrier) and may be associated with an identifier for distinguishing neighboring cells (for example, a physical cell identifier (PCID), a virtual cell identifier (VCID)). In some examples, a cell also may refer to a coverage area 110 or a portion of a coverage area 110 (for example, a sector) over which the logical communication entity operates. Such cells may range from smaller areas (for example, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a network entity 105 operating with lower power (for example, a base station 140 operating with lower power) relative to a macro cell, and a small cell may operate using the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (for example, MTC, narrowband IoT (NB-IoT), enhanced mobile broadband (eMBB)) that may provide access for different types of devices.

In some examples, a network entity 105 (for example, a base station 140, an RU 170) may be movable and therefore provide communication coverage for a moving coverage area, such as the coverage area 110. In some examples, coverage areas 110 (for example, different coverage areas) associated with different technologies may overlap, but the coverage areas 110 (for example, different coverage areas) may be supported by the same network entity (for example, a network entity 105). In some other examples, overlapping coverage areas, such as a coverage area 110, associated with different technologies may be supported by different network entities (for example, the network entities 105). The wireless communications system 100 may include, for example, a heterogeneous network in which different types of the network entities 105 support communications for coverage areas 110 (for example, different coverage areas) using the same or different RATs.

The wireless communications system 100 may support synchronous or asynchronous operation. For synchronous operation, network entities 105 (for example, base stations 140) may have similar frame timings, and transmissions from different network entities (for example, different ones of the network entities 105) may be approximately aligned in time. For asynchronous operation, network entities 105 may have different frame timings, and transmissions from different network entities (for example, different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (for example, via Machine-to-Machine (M2M) communication). M2M communication or MTC may refer to data communication technologies that allow devices to communicate with one another or a network entity 105 (for example, a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (for example, one or more of the UEs 115) via a device-to-device (D2D) communication link, such as a D2D communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (for example, from 30 GHz to 300 GHz), also known as the millimeter band. In some examples, the wireless communications system 100 may support millimeter wave (mmW) communications between the UEs 115 and the network entities 105 (for example, base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (for example, the same codeword) or different data streams (for example, different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A network entity 105 or a UE 115 may use beam sweeping techniques as part of beamforming operations. For example, a network entity 105 (for example, a base station 140, an RU 170) may use multiple antennas or antenna arrays (for example, antenna panels) to conduct beamforming operations for directional communications with a UE 115. Some signals (for example, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (for example, by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (for example, a network entity 105 or a UE 115) along a single beam direction (for example, a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (for example, by a network entity 105 or a UE 115) may be performed using multiple beam directions, and the device may use a combination of digital precoding or beamforming to generate a combined beam for transmission (for example, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted along one or more directions by a network entity 105 (for example, a base station 140, an RU 170), a UE 115 may employ similar techniques for transmitting signals multiple times along different directions (for example, for identifying a beam direction for subsequent transmission or reception by the UE 115) or for transmitting a signal along a single direction (for example, for transmitting data to a receiving device).

A receiving device (for example, a UE 115) may perform reception operations in accordance with multiple receive configurations (for example, directional listening) when receiving various signals from a transmitting device (for example, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned along a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, the communication link(s) 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in relatively poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, system information (for example, a master information block (MIB)) may be transmitted via a broadcast channel (BCH) according to a periodicity (for example, an 80 ms periodicity), with repetitions (for example, within 80 ms), or both. System information, such as SIB1, may be transmitted on a downlinks hared channel (DL-SCH) according to a periodicity (for example, a periodicity of 160-ms) and variable transmission repetition periodicity (for example, within 160 ms). A default transmission repetition periodicity for SIB1 may be 20 ms, but actual transmission repetition periodicity may be configured or changed according to a network. SIB1 may include information regarding availability and scheduling (for example, mapping of SIBs to SI messages, periodicity, or SI-window size) of other SIBs with an indication whether one or more SIBs are provided on-demand (for example, and in such cases, the configuration needed by the UE 115 to perform the SI request). SIB1 may be a cell-specific SIB.

The SIB1 may include a list of PLMN IDs (for example, and non-public network (NPN) IDs). The corresponding PLMN index (for example, and NPN index) may indicate each identifier (ID) signaled within such lists. Additional information may be conveyed using parallel lists (for example, PLMN-specific information indicated on a field-by-field basis may be signaled with reference to PLMN or NPN indices of IDs listed in SIB1. In some examples, a SIB (for example, SIB1) may include a list of PLMN IDs or NPN IDs. Parallel lists may point to the PLMN indices or NPN indices. Field descriptions (for example, a plmn-IdentityList) may set a field t o a same value for all instances of SIB1 that are broadcast within the same cell. A remainder of PLMN-specific information (for example, which may be conveyed on a field-by-field basis) may be signaled with reference to the PLMN or NPN index of the IDs listed in the SIB1.

The network may broadcast multiple PLMN-specific SIBs. A UE 115 may monitor for system information, and identify SIBs that correspond to relevant PLMNs (for example, PLMNs supported by a current cell, or candidate cell). The UE 115 may also be able to avoid monitoring for and receiving PLMN-specific SIBs that are not relevant to the UE 115 (for example, the UE 115 may not receive and decode one or more SIBs carrying information for irrelevant PLMNs not supported by the UE). In some examples, a common SIB (for example, SIB1) may include a list of PLMN identifiers (IDs) indicating PLMN-specific SIBs, and the common SIB may indicate scheduling information for multiple PLMN-specific SIBs (for example, each PLMN-specific SIB including PLMN-specific fields for one of the PLMN IDs). In some examples, a common SIB (for example, SIB1) may include implicit or explicit scheduling information for multiple PLMN-specific SIBs. Each PLMN-specific SIB may include a PLMN ID and system information for the indicated PLMN. In such examples, the UE 115 may monitor for and receive the PLMN-specific SIBs to identify the PLMN ID relevant to the UE, and may stop monitoring for and decoding any additional PLMN-specific SIBs upon decoding the PLMN-specific SIB corresponding to the PLMN ID that is relevant to the UE. In some examples, the common SIB (SIB1) may include common parameters corresponding to all PLMNs, and only unique PLMN-specific system information may be included in the PLMN-specific SIBs. In some examples, the network may broadcast a SIB1 for each PLMN, and each SIB1 may include scheduling information for additional PLMN-specific SIBs for one PLMN and a complete list of PLMN IDs. A UE 115 may receive a first SIB1 for a first PLMN and either utilize the PLMN-specific SIB1 to identity the additional PLMN-specific SIBs for the first PLMN (for example, if the PLMN is relevant to the UE 115), or the UE 115 may determine that another SIB1 exists for a second PLMN based on the list of PLMN IDs in the first SIB1 (for example, and the UE 115 may then monitor for and receive the other relevant SIB1 for the second PLMN).

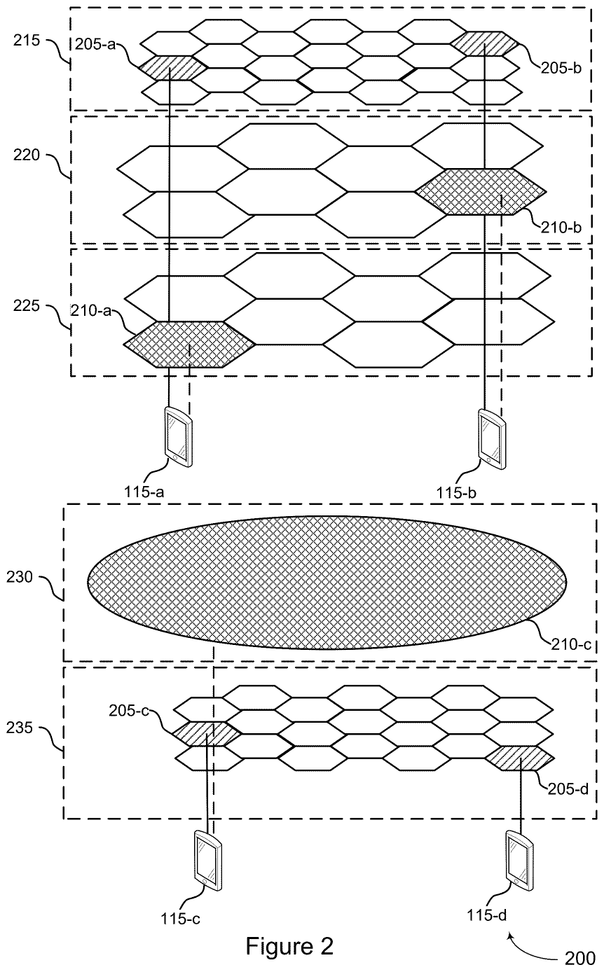

FIG. 2 shows an example of a wireless communications system 200 that supports network-specific system information designs and signaling in accordance with one or more aspects of the present disclosure. The wireless communications system 200 may implement, or be implemented by, aspects of the wireless communications system 100. For example, the wireless communications system 200 may include one or more UEs 115 (for example, the UE 115-a, the UE 115-b, the UE 115-c, and the UE 115-d), and one or more network entities (for example, network entities 105), which may be examples of corresponding devices described with reference to FIG. 1). A UE 115 may be connected to (for example, camped on) a current cell 205, and may monitor for system information from (for example, and in some cases, switch to) a candidate cell 210 (for example, a reselection candidate cell).

The wireless communications system 200 may support multiple networks (for example, multiple PLMNs). For example, a RAN may be shared between different PLMNs, or between NPNs. In some examples, RAN sharing may be performed via a multi-operator core network (MOCN). An MOCN may experience some limitations when a shared RAN overlaps with an MNO-dedicated RAN. For instance, some cells may support a single PLMN, and other cells may support multiple PLMNs.

The wireless communications system 200 may support RAN overlay deployments. For instance, the UE 115-a may be located in a first cell corresponding to a first geographic coverage area. In such cases, a same frequency (for example, carrier frequency) may be associated with multiple cells having different cell identifiers, and at least one cell may be associated with multiple PLMN identities. For example, MOCN functionality may allow a network operator to provide access to a single RAN by other operators, where each operator operates its own core network, including one or more independent network nodes. In such examples, a first set of cells 215 may be associated with a first frequency range (for example, FR3, corresponding to a first PLMN (for example, PLMN 1) and a second PLMN (for example, PLMN 2)), a second set of cells 220 may be associated with a second frequency range (for example, FR1, Band Y, corresponding to the PLMN 2), and a third set of cells 225 may be associated with a third frequency range (for example, FR1, Band X, corresponding to the PLMN 1).

In an MOCN scenario, some system information (for example, one or more SIBs) may be specific to a particular PLMN. However, without a mechanism to convey PLMN specific system information to only those UEs 115 corresponding to a given PLMN, all UEs 115 may expend energy attempting to receive and decode system information that is relevant to other PLMNs. Some MOCN deployments may lack any PLMN specific system information. In some examples, a SIB may include PLMN-specific information in a list of information elements (IEs) or fields. In an MOCN scenario, where a single DU is connected to multiple CUs, PLMN-specific information may be conveyed from a PLMN-specific CU. In such examples, the DU may generate a single SIB containing all PLMN-specific information within the same SIB, and may transmit such information via a single DU, which may result in excessive information or an excessively large SIB. In such examples, a given UE 115 may expend a large amount of time and power to monitor for, receive, and decode one or more SIBs, only to receive and decode PLMN-specific information that is not applicable to the UE 115.

In the case of SI on demand, when a UE 115 requests a given SIB, the DU may identity a correct CU to contact for the updated SIB. Such information may be unavailable to the DU, or obtaining such information may result in additional signaling overhead. Changes in some or part of a SIB due to additions, removals, or updates of one PLMN-specific information may trigger a system information update for all UEs 115 and all PLMNs (for example, even if one or more UEs has not requested information for all PLMNs, or any PLMNs). Such unnecessary system information updates may result in additional signaling overhead, increased expenditures of power, decreased battery life, inefficient use of available system resources, and decreased user experience.

For example, the UE 115-a may be camped on a first cell 205-a, but may perform a mobility procedure and switch to a candidate cell 210-a (for example, which may be referred to as a reselection candidate cell). While camped on the cell 205-a, the UE 115-a may benefit from receiving system information corresponding to both the PLMN 1 and the PLMN 2. However, upon switching to the candidate cell 210-a, the UE 115-a may only utilize system information corresponding to the PLMN 1. Similarly, the UE 115-b may be camped on the cell 205-b (for example, in the first set of cells 215). However, upon switching to the cell 210-b in the second set of cells 220 (for example, which only supports the PLMN 2), the UE 115-b may only utilize information corresponding to the PLMN 2. If a cell provides system information for both the PLMN 1 and the PLMN 2, the UE 115-a and the UE 115-b may expend time and energy receiving and decoding system information for both the PLMN 1 and the PLMN 2 (for example, while the UE 115-a may not have any reason to receive or utilize system information corresponding to the PLMN 2, and the UE 115-b may not have any reason to receive or utilize system information correspond not the PLMN 1). The wireless communications system 200 may be more efficient if PLMN-specific system information were conveyed by the network to UEs 115 (for example, instead of transmitting all PLMN relevant information for all PLMNs to UEs 115).

Similarly, the UE 115-c may be camped on the cell 205-c in the in the set of cells 235 (for example, which may correspond to a terrestrial network shared by the PLMN 1 and the PLMN 2). The UE 115-d may also be camped on the cell 205-d in the terrestrial network. The UE 115-c may support communications via a non-terrestrial network (NTN) cell such as the cell 210-c in a set of NTN cells 230. The UE 115-d may not support re-selection of a cell from the set of NTN cells 230. System information corresponding to the PLMN 1 and the PLMN 2 may be provided to the UE 115-c. However, the UE 115-d may rely on system information for the PLMN 2 (for example, but may have no reason to receive system information for the PLMN 1).

In some examples, a UE 115 (for example, such as the UE 115-c) may benefit from PLMN-specific system information for multiple PLMNs. Some UEs 115 (for example, the UE 115-a and the UE 115-b) may benefit from PLMN-specific system information for one or more specific PLMNs, but may unnecessarily expend power and time to receive PLMN-specific information for PLMNs not supported by a current cell or not needed by the UE 115. However, without a mechanism for the network to efficiently provide PLMN-specific system information, or a mechanism by which a UE 115 is able to identify relevant PLMN-specific system information and ignore irrelevant PLMN-specific system information, all UEs 115 served by a given cell may receive all relevant and irrelevant PLMN-specific system information. Such system information signaling may result in inefficient use of available system resources (for example, due to signaling of irrelevant system information), increased power expenditures by one or multiple UEs 115, decreased battery life, increased system delays and latency, and decreased user experience.

The network may convey PLMN-specific system information to UEs 115 according to techniques described herein. The network may broadcast PLMN-specific system information via PLMN-specific SIBs. Different SIBs may be specific to different PLMNs. For example, a SIB (for example, SIB8) may carry information for a first PLMN (for example, PLMN A), and another SIB (for example, another SIB 8) may carry information for a second PLMN (for example, PLMN B). The network may transmit the first SIB8 and the second SIB8 as separate SIBs (for example, instead of as a single SIB including information for multiple PLMNs).

As a result of broadcasting PLMN-specific SIBs, a UE 115 may be able to read (for example, receive and decode) the SIBs that correspond to the relevant PLMN for the UE 115 (for example, in case of different vertical sharing RANs or RAN overlays, as illustrated with reference to FIG. 2). The network may generate different SIB information and messages for different PLMNs, as needed. The network may broadcast additional SIBs for additional PLMNs as needed (for example, without indicating system information modifications to older SIBs). The network may convey system information without resulting in an unreasonable SIB size (for example, because the network does not include all system information for all PLMNs in a single SIB).

Techniques described herein support PLMN-specific SIBs, including differentiating and indicating which SIB corresponds to which PLMN, indicating scheduling information for PLMN-specific SIBs, inter-node signaling for PLMN-specific SIBs, and common system information for multiple PLMNs (for example, some PLMN-specific information may be conveyed in terms of a delta from a default or common value). In some cases (for example, some PLMNs may be redundant or duplicates in a list of PLMNs), a default SIB may apply to all PLMNs unless PLMN-specific is present. In some cases, more than one PLMN may share some PLMN-specific SIBs, and some PLMNs may correspond to different PLMN-specific SIBs.

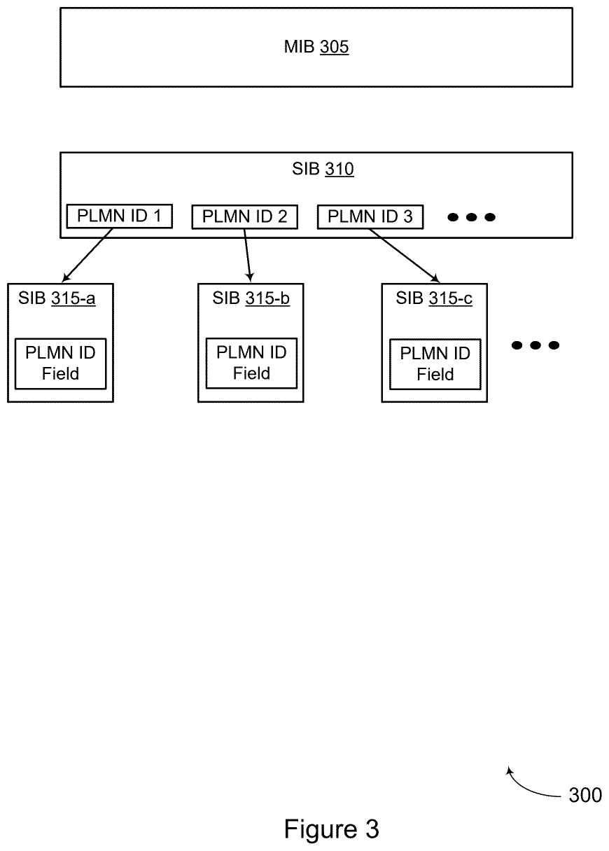

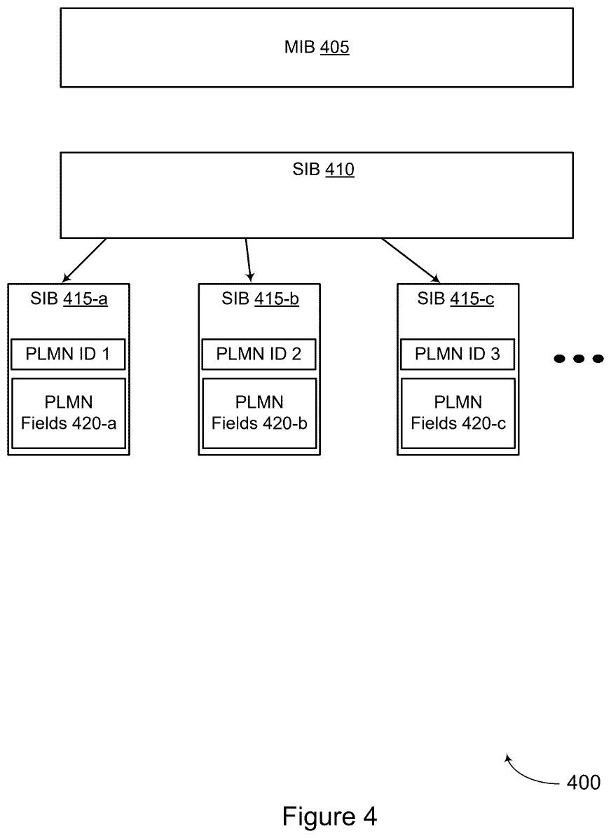

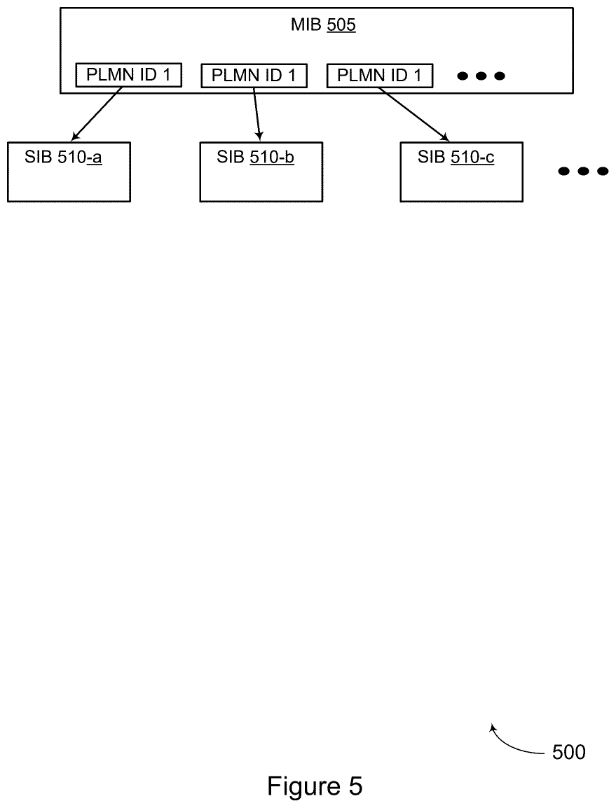

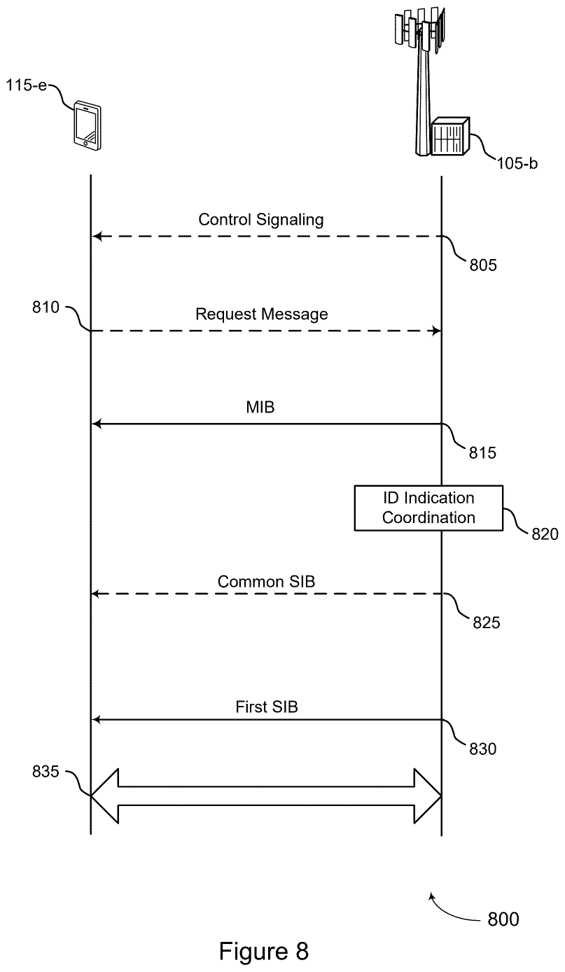

Techniques for providing PLMN ID information for PLMN-specific SIBs are described in greater detail with reference to FIGS. 3-4. Techniques for utilizing PLMN-specific SIBs in combination with or instead of common SIBs (for example, SIB1) are described in greater detail with reference to FIGS. 5-7. Signaling in support of PLMN-specific SIBs is described in greater detail with reference to FIG. 8.

FIG. 3 shows an example of a system information scheme 300 that supports network-specific system information designs and signaling in accordance with one or more aspects of the present disclosure. The system information scheme 300 may implement, or be implemented by, aspects of the wireless communications system 100 and the wireless communications system 200. For example, a network entity (for example, a network entity 105) and one or more UEs (for example, UEs 115), which may be examples of corresponding devices as described with reference to FIGS. 1-2, may communicate in accordance with the system information scheme 300.

In some examples, as described with reference to FIG. 3, PLMN specific information and PLMN IDs may be provided to one or more UEs in accordance with the system information scheme 300. For example, a network entity may broadcast a MIB 305 and a SIB 310, and may provide an indication of PLMN IDs being served by a given cell. In some examples, the PLMN IDs served by the cell may be provided as a list of PLMN IDs or NPN IDs in a common SIB 310 (for example, SIB1). The SIB 1 may be common to all PLMNs, and may include a list of PLMN IDs for the PLMNs being served by the cell. Any reference to a PLMN index from other signaling (for example, the SIBs 315) may be mapped back to the PLMN IDs listed in the SIB 310.

The SIB1 may including mapping information (for example, scheduling information) for one or more additional PLMN-specific SIBs. For example, the list of PLMN IDs in the SIB 310 may include the PLMN ID 1, the PLMN ID 2, and the PLMN ID 3 (for example, for three PLMNs served by the cell). The SIB 315-a may include one or more PLMN-specific fields indicated by or including a value corresponding to the PLMN ID 1. The SIB 315-b may include one or more PLMN-specific fields indicated by or including a value corresponding to the PLMN ID 2. The SIB 315-c may include one or more PLMN-specific fields indicated by or including a value corresponding to the PLMN ID 3.

In some examples, each PLMN-specific SIB may include its own PLMN ID (for example, instead of the PLMN IDs being included in the common SIB 310), as described in greater detail with reference to FIG. 4.

FIG. 4 shows an example of a system information scheme 400 that supports network-specific system information designs and signaling in accordance with one or more aspects of the present disclosure. The system information scheme 400 may implement, or be implemented by, aspects of the wireless communications system 100, the wireless communications system 200, the system information scheme 300, or any combination thereof. For example, a network entity (for example, a network entity 105) and one or more UEs (for example, UEs 115), which may be examples of corresponding devices as described with reference to FIGS. 1-3, may communicate in accordance with the system information scheme 400.

In some examples, PLMN IDs (for example, or NPN IDs) may be included in each PLMN-specific SIB (for example, the SIBs 415, which may be referred to as a SIB1, or a SIBX). For example, the network entity may broadcast a MIB 405 (for example, which may include scheduling information for a SIB 410 (for example, a SIB1). The SIB1 may indicate (for example, implicitly or explicitly) all SIBs being broadcast by the network entity (for example, including one or more PLMN-specific SIBs 415).

A UE may receive and read each PLMN-specific SIB 415 until the UE identifies a SIB 415 corresponding to a PLMN in which the UE is interested (for example, a UE that is relevant to a PLMN supported by the UE). For example, the UE may search for PLMN-specific system information corresponding to a first PLMN (for example, corresponding to the PLMN 1). The UE may monitor for and receive (for example, read) the SIB 415-a. The SIB 415-a may include the PLMN ID, and one or more PLMN fields 420-a (for example, indicating parameters for the first PLMN). Having received the PLMN-specific system information for the first PLMN, the UE may not read (for example, may refrain from monitoring for or decoding) any additional PLMN-specific SIBs 415 (for example, the UE may not read the SIB 415-b including the PLMN fields 420-b, and may not read the SIB 415-c including the PLMN fields 420-c). By implementing such techniques, the UE may conserve power.

If the UE is searching for PLMN-specific system information corresponding to a second PLMN (for example, corresponding to the PLMN 2). The UE may monitor for and receive (for example, read) the SIB 415-a. Having determine that the SIB 415-a does not include the PLMN-specific system information for the second PLMN (for example, based on the PLMN ID 1 in the SIB 415-a), the UE may continue to monitor for and receive additional SIBs 415. The UE may continue to monitor for and receive one or more additional SIBs 415. The UE may read the PLMN-specific SIB 415-b (for example, in accordance with scheduling information in the SIB 410). The UE may determine that the SIB 415-b includes PLMN-specific information for the second PLMN based on the PLMN ID 2. The UE may read (for example, receive and decode) the PLMN fields 420-b for the second PLMN. Having received the PLMN-specific system information for the second PLMN in the PLMN-specific SIB 415-b, the UE may not read (for example, may refrain from monitoring for or decoding) any additional PLMN-specific SIBs 415 (for example, the UE may not read the SIB 415-c including the PLMN fields 420-c).

In such examples, PLMN-specific SIBs may be smaller because no PLMN-specific SIB carries a full list of PLMN IDs. Further, PLMN IDs are not interdependent on other SIBs (for example, the PLMN IDs in the SIBs 415 do not rely on mapping back to the SIB 410). The SIB 410 may be small because the SIB 410 does not include a full list of PLMN IDs. The size of the SIBs 415 and the SIB 410 may result in more efficient use of system resources and decreased signaling overhead). Further, the UE may conserve power and computational resources by refraining from monitoring additional SIBs 415 upon reading the SIB 415 that includes relevant PLMN information.

PLMN-specific information, or PLMN IDs, or both, may be included in a MIB, a common SIB, or one or more PLMN-specific SIBs, as described in greater detail with reference to FIGS. 5-7.

FIG. 5 shows an example of a system information scheme 500 that supports network-specific system information designs and signaling in accordance with one or more aspects of the present disclosure. The system information scheme 500 may implement, or be implemented by, aspects of the wireless communications system 100, the wireless communications system 200, the system information scheme 300, the system information scheme 400, or any combination thereof. For example, a network entity (for example, a network entity 105) and one or more UEs (for example, UEs 115), which may be examples of corresponding devices as described with reference to FIGS. 1-4, may communicate in accordance with the system information scheme 500.

In some examples, each SIB 510 (for example, basic SIBs, such as SIB1) may be PLMN-specific. In such examples, PLMN ID information (for example, or NPN ID information) may be provided prior to broadcasting the SIBs 510 (for example, via the MIB 505). For example, the network may broadcast the MIB 505, which may include a list of PLMN IDs (for example, and scheduling information for the SIBs 510). The SIB 510-a may include system information for a first PLMN corresponding to the PLMN ID 1, the SIB 510-b may include system information for a second PLMN corresponding to the PLMN ID 2, the SIB 510-c may include system information for a third PLMN corresponding to the PLMN ID 3, or other PLMNs. Such signaling may result in a relatively large MIB 505. SIB1 scheduling information (for example, for the SIBs 510) may be included in the MIB 505, and may depend on a quantity of SIB1s to be accommodated (for example, and may be based on a fixed periodicity for the SIBs 510, the MIB 505, or both). System information modification short messages may indicate which SIB1 (for example, which SIB 510-a) is updated.

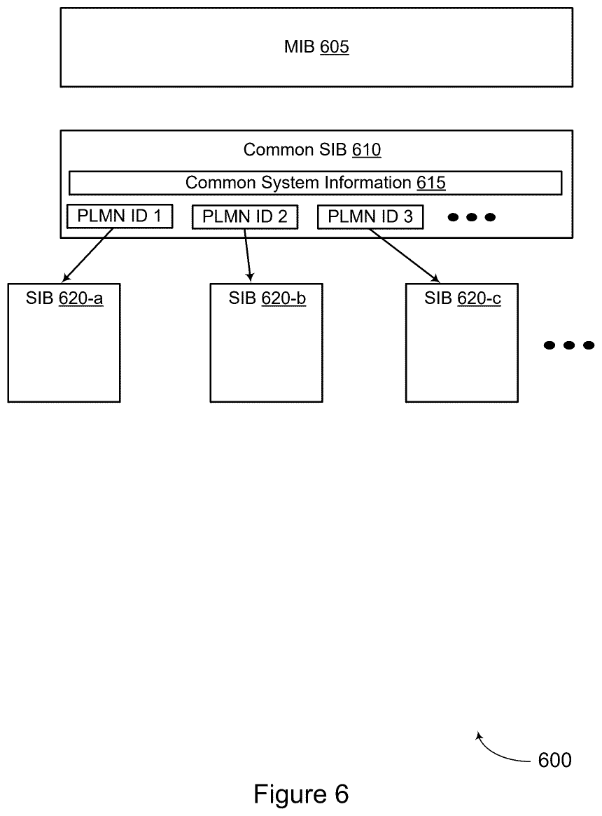

In some examples, as described in greater detail with reference to FIG. 6, a common SIB (for example, a SIB1) may include common parameters for all PLMNs supported by a cell, and additional SIBs (for example, SIB2) may be PLMN-specific.

FIG. 6 shows an example of a system information scheme 600 that supports network-specific system information designs and signaling in accordance with one or more aspects of the present disclosure. The system information scheme 600 may implement, or be implemented by, aspects of the wireless communications system 100, the wireless communications system 200, the system information scheme 300, the system information scheme 400, the system information scheme 500, or any combination thereof. For example, a network entity (for example, a network entity 105) and one or more UEs (for example, UEs 115), which may be examples of corresponding devices as described with reference to FIGS. 1-5, may communicate in accordance with the system information scheme 600.

The network may broadcast a MIB 605, which may include scheduling information for a common SIB 610. In some examples, the common SIB 610 (for example, a SIB1) may include common system information 615. The common system information 615 may include all common parameters that apply to all of the PLMNs served by the cell. The Common SIB 610 may also include a list of PLMN IDs for all the PLMNs served by the cell, scheduling information (for example, implicit or explicit) for the PLMN-specific SIBs 620, or both.

The PLMN-specific SIBs 620 may include PLMN-specific system information for each of the PLMNs indicated in the list of PLMN IDs included in the common SIB 610. In some examples, the PLMN-specific SIBs 620 may be referred to as SIB2 or SIBX. For each PLMN, the network entity may broadcast a separate SIB 620 (for example, a SIB2) including PLMN-specific IEs or fields. A location for any PLMN parameter or PLMN-related field may be determined in accordance with whether the PLMN parameter is common to the list of PLMNs served by the cell, or specific to one or more PLMNs. Common PLMN parameters or fields may be included in the common SIB 610 (for example, I the common system information 615), while PLMN-specific parameters or fields may be included in a corresponding PLMN-specific SIB 620.

For a particular UE interested in a given PLMN, the UE may consider only the corresponding SIB 620 to be relevant (for example, essential or required). For instance, a UE may search for PLMN information for a second PLMN corresponding to the PLMN ID 2. In such examples, the UE may receive the common SIB 610 including the common system information 615. The UE may receive the common PLMN parameters relevant to all the served PLMNs including the second PLMN. The UE may also monitor for and receive the SIB 620-b corresponding to the PLMN ID 2 (for example, based on scheduling information in the common SIB 610). The UE may receive the PLMN-specific system information for the second PLMN via the SIB 620-b (for example, but may ignore or refrain from receiving and decoding the SIB 620-a, the SIB 620-c, or both).

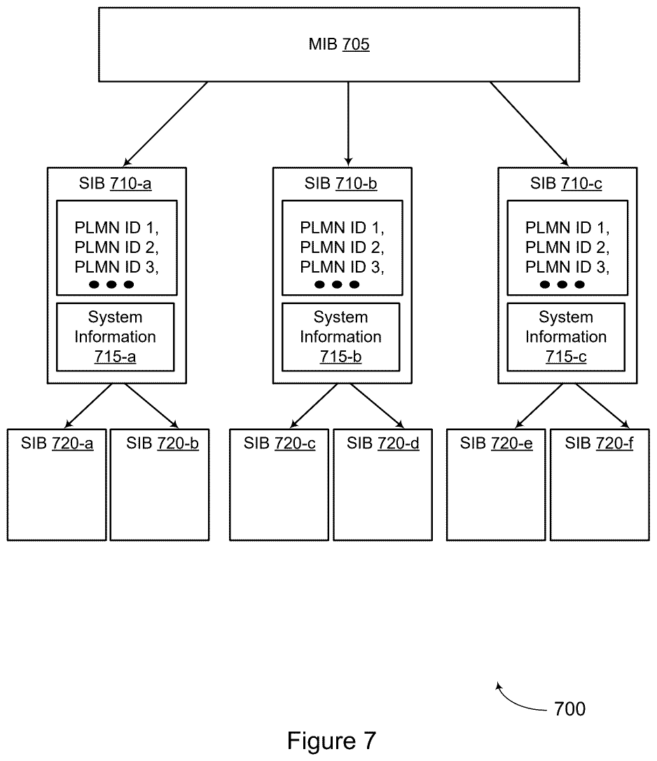

In some examples, each PLMN-specific SIB may include an entire PLMN list, as described in greater detail with reference to FIG. 7.

FIG. 7 shows an example of a system information scheme 700 that supports network-specific system information designs and signaling in accordance with one or more aspects of the present disclosure. The system information scheme 700 may implement, or be implemented by, aspects of the wireless communications system 100, the wireless communications system 200, the system information scheme 300, the system information scheme 400, the system information scheme 500, the system information scheme 600, or any combination thereof. For example, a network entity (for example, a network entity 105) and one or more UEs (for example, UEs 115), which may be examples of corresponding devices as described with reference to FIGS. 1-6, may communicate in accordance with the system information scheme 700.

The network entity may transmit a MIB 705. The MIB 705 may indicate (for example, may include scheduling information) one or more SIBs 710. IN some examples, each SIB 710 may be examples of a SIB1. Each SIB 710 may be PLMN-specific. Each PLMN-specific SIB 710 may also include a list of PLMN IDs served by the cell. However, each PLMN-specific SIB may be different from the other PLMN-specific SIBs. For instance, the SIB 710-a may include a list of PLMN IDs (for example, the PLMN ID 1 for a first PLMN served by the cell, the PLMN ID 2 for a second PLMN served by the cell, the PLMN ID 3 for a third PLMN served by the cell), and system information 715-a, which may include an indication of (for example, scheduling information for) a set of one or more PLMN-specific SIBs 720 (for example, the SIB 720-a and the SIB 720-b). In some examples, the SIBs 720 may be referred to as SIBX and SIBY for a first PLMN (for example, corresponding to the PLMN ID 1). Similarly, the SIB 710-b may include the full list of PLMN IDs for PLMNs served by the cell, and system information 715-b for the second PLMN (for example, indicating the PLMN-specific SIB 720-c and the PLMN-specific SIB 720-d for the second PLMN). The SIB 710-c may include the same list of PLMN IDs, and system information 715-c for the third PLMN (for example, indicating the PLMN-specific SIB 720-e and the SIB 720-f for the third PLMN).

The UE may read a SIB1 (for example, a SIB 710), and may determine which PLMNs are supported by the cell. If the PLMN that is relevant to the UE is included in the list of PLMN IDs, then the UE may monitor for and identify scheduling information of the SIB 710, the SIB 720, or both, corresponding to the relevant PLMN. Each PLMN-specific SIB 710 may also include access barring information for all PLMNs (for example, or NPNs) so that the UE is not required to read multiple SIBs before figuring out whether a PLMN is allowed or not. For instance, the UE may be interested in a fourth PLMN. The UE may receive the SIB 710-a and may read the list of PLMN IDs. Having determined that a PLMN ID 4 for the fourth PLMN is not included in the list of PLMN IDs, the UE may refrain from reading any additional SIBs 710, or SIBs 720. In some examples, the UE may search for a second PLMN. Upon reading the SIB 710-a, the UE may determine that the second PLMN corresponding to the PLMN ID 2 is supported by the cell. The UE may refrain from monitoring for the SIB 720-a and the SIB 720-b, which may carry PLMN-specific information for the first PLMN corresponding to the PLMN ID 1. The UE may monitor for and receive (for example, based on detecting the PLMN ID 2 in the list of PLMN IDs, and based on the MIB 705) the SIB 710-b. The SIB 710-b may include system information 715-b corresponding to the PLMN ID 2. The UE may monitor for and receive the SIB 720-c and the SIB 720-d for the second PLMN. Having received the PLMN-specific information in the SIB 720-c and the SIB 720-d, the UE may refrain from monitoring for additional irrelevant system information (for example, may refrain from receiving or reading the SIB 710-c, the SIB 720-e, and the SIB 720-f).

FIG. 8 shows an example of a process flow 800 that supports network-specific system information designs and signaling in accordance with one or more aspects of the present disclosure. The process flow 800 may implement, or be implemented by, aspects of the wireless communications system 100, the wireless communications system 200, the system information scheme 300, the system information scheme 400, the system information scheme 500, the system information scheme 600, the system information scheme 700, or any combination thereof. For example, the process flow 800 may include a network entity 105-b, and a UE 115-e, which may be examples of corresponding devices as described with reference to FIGS. 1-7.

At 815, the UE 115-e may receive (for example, from the network entity 105-b) a MIB indicating at least a set of SIBs (for example, PLMN-specific SIBs). Each SIB of the set of PLMN-specific SIBs may correspond to a respective PLMN of a set of PLMNs supported by a first cell.

At 830, the UE 115-e may receive (for example, from the network entity 105-b) at least a first SIB (for example, a PLMN-specific SIB) corresponding to a first PLMN (for example, corresponding to PLMN ID 1, PLMN ID 2, PLMN ID 3).

At 835, the UE 115-e may perform wireless communications (for example, with the network entity 105-b) via at least the first PLMN in accordance with the first SIB.

In some examples, the first SIB received at 830 may include a first PLMN ID of the first PLMN, as described in greater detail with reference to FIG. 4. In such examples, the UE 115-e may refrain from receiving at least a second SIB (for example, such as the SIB 415-b or the SIB 415-c) of the set of SIBs corresponding to the second PLMN in accordance with the first SIB including the first PLMN ID (for example, if the UE does not support the second PLMN).

In some examples, the MIB received at 815 may include a list of PLMN IDs, as described in greater detail with reference to FIG. 5. Each PLMN ID in the MIB may correspond to a respective SIB of the set of SIBs. The UE 115-e may receive the first SIB at 830 based on mapping information for the PLMN IDs indicated in the MIB.

In some examples, at 825, the UE 115-e may receive a common SIB including a list of PLMN IDs corresponding to respective PLMNs of the set of PLMNs, as described in greater detail with reference to FIG. 6. The PLMN IDs of the list of PLMN IDs may correspond to a respective SIB of the set of SIBs in accordance with a mapping. All parameters that are common to the PLMNs served by the cell may be included in the common SIB, and PLMN-specific system information for each PLMN may be included in additional SIBs (for example, including the first SIB).

In some examples, the UE 115-e may receive a common SIB at 825 including an indication of one or more additional SIBs (for example, such as the SIBs 720 as described in greater detail with reference to FIG. 7). If the UE 115-e is not interested in the PLMN indicated by a first common SIB (for example, received at 825), the UE 115-e may monitor for at least a second common SIB in accordance with the first common SIB and the list of PLMN identifiers (for example, the UE 115-e may monitor for the SIB 710-b). Based on the additional monitoring in accordance with the list of PLMN IDs received in the first common SIB, the UE 115-e may receive one or more additional SIBs in accordance with the first SIB, the additional SIBs, or both.

In some examples, the UE 115-e may receive control signaling at 805. For example, the UE 115-e may receive an indication of a first type of system information corresponding to at least one PLMN of the set of PLMNs, and of a second type of system information corresponding to a second set of PLMNs. In some examples, the second set of PLMNs may not correspond to the set of PLMN-specific SIBs. For example, scheduling information (for example, as described with reference to the MIB, a common SIB, or a PLMN-specific SIB with reference to FIGS. 2-8) may be indicated according to an equation based on system information window length, an order of system information messages listed in an IE (for example, schedulingInfoList) and corresponding periodicity, among other examples. Each SIB included in a system information message may be indicated by a SIB type (for example, SIB-TypeInfo IE). For PLMN-specific SIBs, scheduling information may be conveyed in accordance with a SIB type. For example, a PLMN-specific SIB (for example, such as a SIB1 with a common MIB) may accommodate multiple SIBs (for example, SIBX corresponding to multiple PLMNs), based on a list of PLMNs given in a SIB1 or MIB, where equations for determining system information scheduling consider the PLMN index (for example, such that a UE can determine the schedule of PLMN-specific SIBs). In the case of a common SIB1, for SIBs which can have PLMN-specific versions, a scheduling information list (for example, schedulingInfoList) may list all PLMN-=specific variations of a SIB (for example, indicating a mapping of a corresponding PLMN index to the SIB number). In some examples, an associated PLMN index for a given system information may be indicated by an IE or field (for example, SIB-TypeInfo) by including a PLMN index in the SIB-TypeInfo parameter or field.

In some examples (for example, at 805), the UE 115-e may receive an indication of a paging radio network temporary identifier (P-RNTI) corresponding to the first PLMN. The UE 115-e may monitor for system information modification signaling for the first PLMN in accordance with the P-RNTI. For example, the UE 115-e may monitor for system modification information (for example, a short message for systemInfoModification). There may be PLMN-specific P-RNTIs configured, so that the UE 115-e belong to that PLMN does not need to monitor for system information updates for other irrelevant PLMNs. For the scenarios where the UE 115-e searches for PLMN-specific SIBs for more than one PLMN (for example, a dual steering deployment), the UE 115-e may monitor for multiple P-RNTIs. In some examples, the PLMN ID indices may be indicated in or by the short message.

In some examples, the UE 115-e may request PLMN-specific SIBs (for example, in an on-demand scenario). The UE 115-e may transmit a request message at 810, and may receive the PLMN-specific SIB (for example, at 830 or 825 or both) based on the request message. For example, the UE may indicate a PLMN ID index (for example, in addition to a SIB ID) to request the PLMN-specific SIB. The UE 115-e may transmit an explicit request message, such as an RRCSystemInfoRequest message including a field to indicate the PLMN ID, a PLMN index pointing to the SIB 1 list of PLMNs, or the like. In some examples, the UE 115-e may implicitly indicate the PLMN ID. For example, the UE 115-e may receive or transmit a system information scheduling information message, which may include all PLMN-specific SIBs, and the UE 115-e may implicitly indicate the PLMN ID based on the index of the system information requested. In some examples, the UE 115-e may transmit a random access message (for example, a message 3 in a random access procedure) implicitly indicating an interested PLMN (for example, in the case where a restriction is applied such that the UE 115-e is only interested in one PLMN at a time).

In some examples, at 820, the network entity 105-b may perform ID indication coordination for the PLMNs. For example, some SIBs may be generated by a DU corresponding to the network entity 105-b, and others may be generated by a CU associated with the network entity 105-b. In some examples, the CU may transmit a system information delivery message (for example, a systemInformationDeliveryCommand message) to the DU to provide a PLMN-specific SIB to the DU. In such examples, the CU may include, in the message, an indication of the PLMN ID when providing PLMN-specific upper SIBs to DUs in a setup response procedure. The CU may include such indications of PLMNs for PLMN-specific information to be transmitted by a DU.

In some examples, PLMN-specific SIBs may be provided in a dedicated manner. A corresponding PLMN ID or NPN ID may be indicated explicitly or implicitly. For example, a SIB may include an associated PLMN ID or NPN ID. In some examples, a field outside of a SIB container may be included in or with a SIB to indicate a PLMN or NPN ID. IN some examples, if the UE 115-e can be connected to a threshold (for example, maximum) PLMN or NPN, and t hen the provided SIB may be implicitly indicated for that PLMN or NPN.

In some examples (for example, at 805), the UE 115-e may receive an indication of (for example, or may otherwise identify), a default SIB (for example, SIBX) which may apply to all PLMNs unless PLMN-specific SIBs are present. In such examples, a large quantity of PLMNs may be supported by a cell, and a list of PLMN-specific SIBs may result in redundancy, or duplicate PLMNs. In such examples, more than one PLMN may share a same PLMN-specific SIB, while other PLMNs may correspond to different PLMN-specific SIBs. Some parameters may be common to multiple PLMNs. In such examples, delta signaling may be utilized among different PLMN-specific versions of a same SIB (for example, PLMN-specific system information may be indicated in a PLMN-specific SIB as a delta or offset from a default SIB or another SIB).

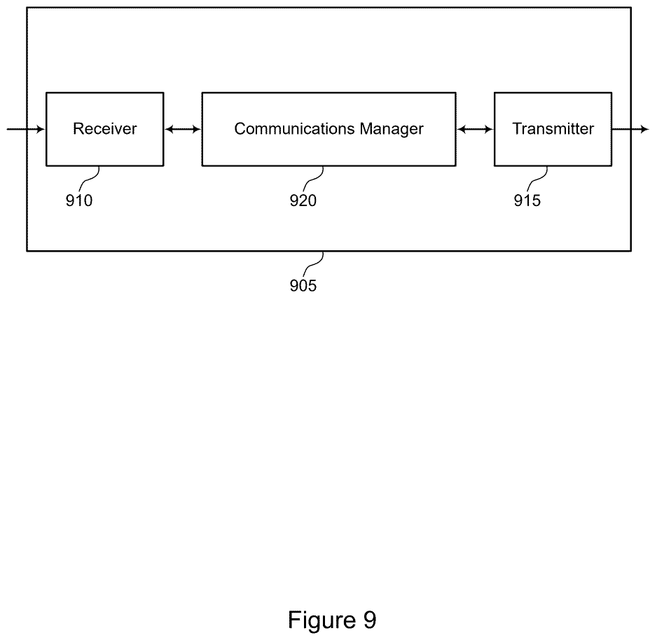

FIG. 9 shows a block diagram of a device 905 that supports network-specific system information designs and signaling in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (for example, the receiver 910, the transmitter 915, the communications manager 920), may include at least one processor, which may be coupled with at least one memory, to, individually or collectively, support or enable the described techniques. Each of these components may be in communication with one another (for example, via one or more buses).

The receiver 910 may provide a means for receiving information such as packets, user data, control information, or any combination thereof associated with various information channels (for example, control channels, data channels, information channels related to network-specific system information designs and signaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example, control channels, data channels, information channels related to network-specific system information designs and signaling). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of network-specific system information designs and signaling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 920, the receiver 910, the transmitter 915, or various combinations or components thereof may be implemented in code (for example, as communications management software or firmware) executed by at least one processor (for example, referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 920 may be configured to perform various operations (for example, receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a MIB indicating at least a set of SIBs, each SIB of the set of SIBs corresponding to a respective PLMN of a set of PLMNs supported by a first cell. The communications manager 920 is capable of, configured to, or operable to support a means for receiving at least a first SIB of the set of SIBs corresponding to a first PLMN of the set of PLMNs supported by the UE in accordance with receiving the MIB. The communications manager 920 is capable of, configured to, or operable to support a means for performing wireless communications via at least the first PLMN in accordance with the first SIB.

By including or configuring the communications manager 920 in accordance with examples as described herein, the device 905 (for example, at least one processor controlling or otherwise coupled with the receiver 910, the transmitter 915, the communications manager 920, or a combination thereof) may support techniques for efficiently broadcasting PLMN-specific system information resulting in reduced processing by devices, reduced power consumption, more efficient utilization of communication resources, and improved user experience.

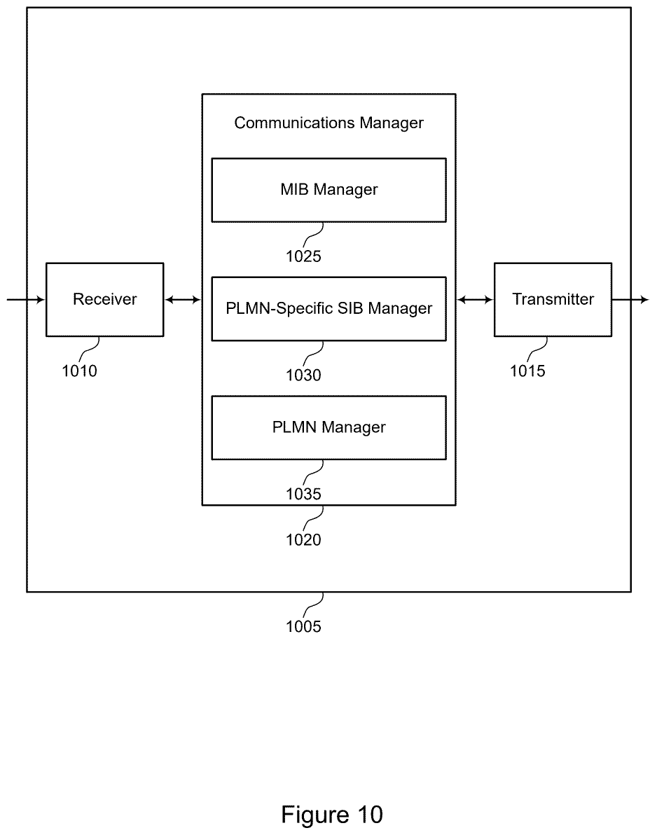

FIG. 10 shows a block diagram of a device 1005 that supports network-specific system information designs and signaling in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (for example, the receiver 1010, the transmitter 1015, the communications manager 1020), may include at least one processor, which may be coupled with at least one memory, to support the described techniques. Each of these components may be in communication with one another (for example, via one or more buses).

The receiver 1010 may provide a means for receiving information such as packets, user data, control information, or any combination thereof associated with various information channels (for example, control channels, data channels, information channels related to network-specific system information designs and signaling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to network-specific system information designs and signaling). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of network-specific system information designs and signaling as described herein. For example, the communications manager 1020 may include a MIB manager 1025, an PLMN-specific SIB manager 1030, an PLMN manager 1035, or any combination thereof. In some examples, the communications manager 1020, or various components thereof, may be configured to perform various operations (for example, receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The MIB manager 1025 is capable of, configured to, or operable to support a means for receiving a MIB indicating at least a set of SIBs, each SIB of the set of SIBs corresponding to a respective PLMN of a set of PLMNs supported by a first cell. The PLMN-specific SIB manager 1030 is capable of, configured to, or operable to support a means for receiving at least a first SIB of the set of SIBs corresponding to a first PLMN of the set of PLMNs supported by the UE in accordance with receiving the MIB. The PLMN manager 1035 is capable of, configured to, or operable to support a means for performing wireless communications via at least the first PLMN in accordance with the first SIB.

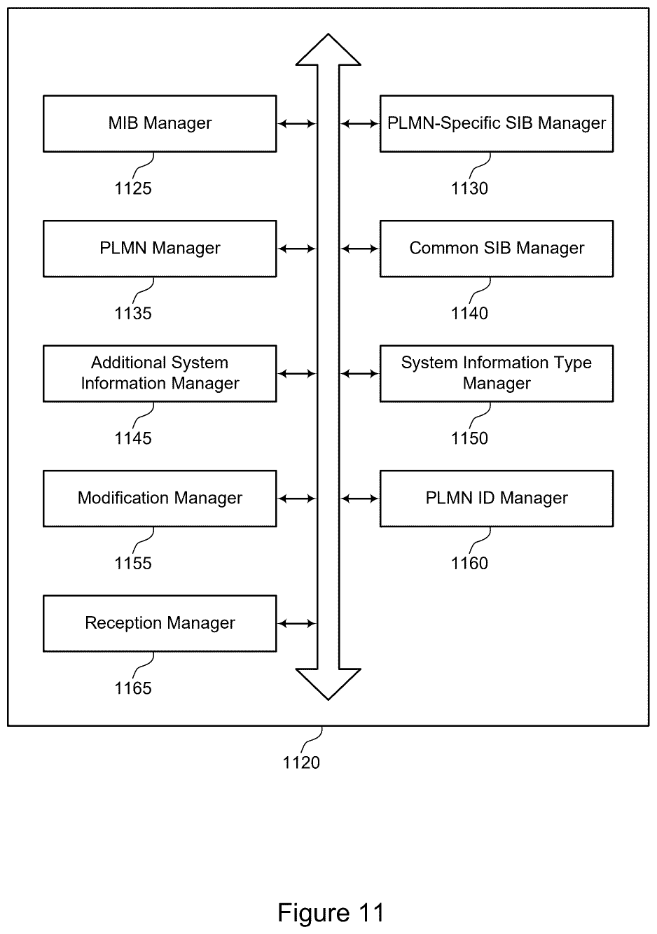

FIG. 11 shows a block diagram of a communications manager 1120 that supports network-specific system information designs and signaling in accordance with one or more aspects of the present disclosure. The communications manager 1120, or various components thereof, may be an example of means for performing various aspects of network-specific system information designs and signaling as described herein. For example, the communications manager 1120 may include a MIB manager 1125, an PLMN-specific SIB manager 1130, an PLMN manager 1135, a common SIB manager 1140, an additional system information manager 1145, a system information type manager 1150, a modification manager 1155, an PLMN ID manager 1160, a reception manager 1165, or any combination thereof. Each of these components, or components or subcomponents thereof (for example, one or more processors, one or more memories), may communicate, directly or indirectly, with one another (for example, via one or more buses).

The communications manager 1120 may support wireless communications in accordance with examples as disclosed herein. The MIB manager 1125 is capable of, configured to, or operable to support a means for receiving a MIB indicating at least a set of SIBs, each SIB of the set of SIBs corresponding to a respective PLMN of a set of PLMNs supported by a first cell. The PLMN-specific SIB manager 1130 is capable of, configured to, or operable to support a means for receiving at least a first SIB of the set of SIBs corresponding to a first PLMN of the set of PLMNs supported by the UE in accordance with receiving the MIB. The PLMN manager 1135 is capable of, configured to, or operable to support a means for performing wireless communications via at least the first PLMN in accordance with the first SIB.

In some examples, the first SIB includes a first PLMN identifier of the first PLMN, where receiving the first SIB of the set of SIBs is in accordance with reading the first PLMN identifier.

In some examples, the reception manager 1165 is capable of, configured to, or operable to support a means for refraining from receiving at least a second SIB of the set of SIBs corresponding to a second PLMN in accordance with the first SIB including the first PLMN identifier, where the UE does not support the second PLMN.

In some examples, the MIB further includes a set of multiple PLMN identifiers corresponding to respective PLMNs of the set of PLMNs, each PLMN identifier of the set of multiple PLMN identifiers corresponding to a respective SIB of the set of SIBs in accordance with a mapping.

In some examples, the common SIB manager 1140 is capable of, configured to, or operable to support a means for receiving, in accordance with the MIB, a common SIB including a set of multiple PLMN identifiers corresponding to respective PLMNs of the set of PLMNs, each PLMN identifier of the set of multiple PLMN identifiers corresponding to a respective SIB of the set of SIBs in accordance with a mapping.

In some examples, the first SIB is a common SIB, and where the first SIB includes an indication of one or more additional SIBs corresponding to the first PLMN, and a list of PLMN identifiers corresponding to the set of PLMNs and where performing the wireless communications via the first PLMN is in accordance with the first SIB and additional system information corresponding to one or more additional SIBs in accordance with the first SIB.

In some examples, the common SIB manager 1140 is capable of, configured to, or operable to support a means for receiving a first common SIB in accordance with receiving the MIB, the first common SIB including system information corresponding to a second PLMN, an indication of one or more additional SIBs corresponding to the second PLMN, and a list of PLMN identifiers corresponding to the set of PLMNs. In some examples, the common SIB manager 1140 is capable of, configured to, or operable to support a means for monitoring for at least a second common SIB in accordance with the first common SIB and the list of PLMN identifiers including a first PLMN identifier corresponding to the first PLMN where the second common SIB is the first SIB, the first SIB including an indication of one or more additional SIBs corresponding to the first PLMN, and the list of PLMN identifiers corresponding to the set of PLMNs. In some examples, the additional system information manager 1145 is capable of, configured to, or operable to support a means for receiving the one or more additional SIBs in accordance with the first SIB, the one or more additional SIBs including additional system information for the first PLMN, where performing the wireless communications via the first PLMN is in accordance with the first SIB and the additional system information.

In some examples, the system information type manager 1150 is capable of, configured to, or operable to support a means for receiving an indication of a first type of system information corresponding to at least one PLMN of the set of PLMNs, and of a second type of system information corresponding to a second set of PLMNs, where the second set of PLMNs do not correspond to the set of SIBs.

In some examples, the modification manager 1155 is capable of, configured to, or operable to support a means for receiving an indication of a P-RNTI) corresponding to the first PLMN. In some examples, the modification manager 1155 is capable of, configured to, or operable to support a means for monitoring for system information modification signaling for the first PLMN in accordance with the P-RNTI.

In some examples, the PLMN ID manager 1160 is capable of, configured to, or operable to support a means for transmitting a request message including a first PLMN identifier corresponding to the first PLMN, the request message indicating a request for the first SIB that is specific to the first PLMN.

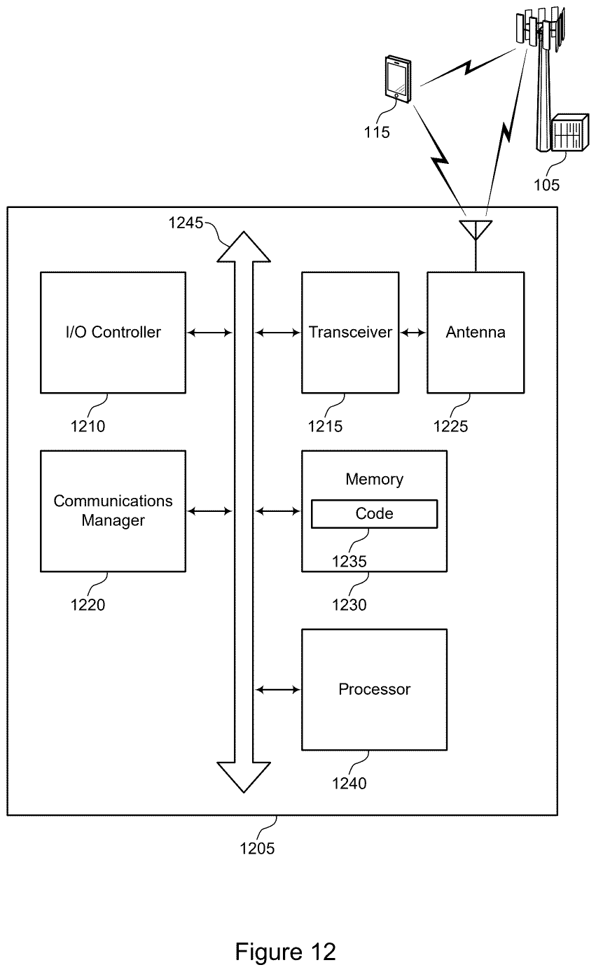

FIG. 12 shows a diagram of a system including a device 1205 that supports network-specific system information designs and signaling in accordance with one or more aspects of the present disclosure. The device 1205 may be an example of or include components of a device 905, a device 1005, or a UE 115 as described herein. The device 1205 may communicate (for example, wirelessly) with one or more other devices (for example, network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (for example, operatively, communicatively, functionally, electronically, electrically) via one or more buses (for example, a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (for example, when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (for example, the at least one memory 1230) to cause the device 1205 to perform various functions (for example, functions or tasks supporting network-specific system information designs and signaling). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (for example, processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a MIB indicating at least a set of SIBs, each SIB of the set of SIBs corresponding to a respective PLMN of a set of PLMNs supported by a first cell. The communications manager 1220 is capable of, configured to, or operable to support a means for receiving at least a first SIB of the set of SIBs corresponding to a first PLMN of the set of PLMNs supported by the UE in accordance with receiving the MIB. The communications manager 1220 is capable of, configured to, or operable to support a means for performing wireless communications via at least the first PLMN in accordance with the first SIB.

By including or configuring the communications manager 1220 in accordance with examples as described herein, the device 1205 may support techniques for efficiently broadcasting PLMN-specific system information resulting in reduced processing by devices, reduced power consumption, more efficient utilization of communication resources, more efficient utilization of communication resources, improved coordination between devices, decreased system latency, increased throughput, and improved user experience.

In some examples, the communications manager 1220 may be configured to perform various operations (for example, receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of network-specific system information designs and signaling as described herein, or the at least one processor 1240 and the at least one memory 1230 may be otherwise configured to, individually or collectively, perform or support such operations.

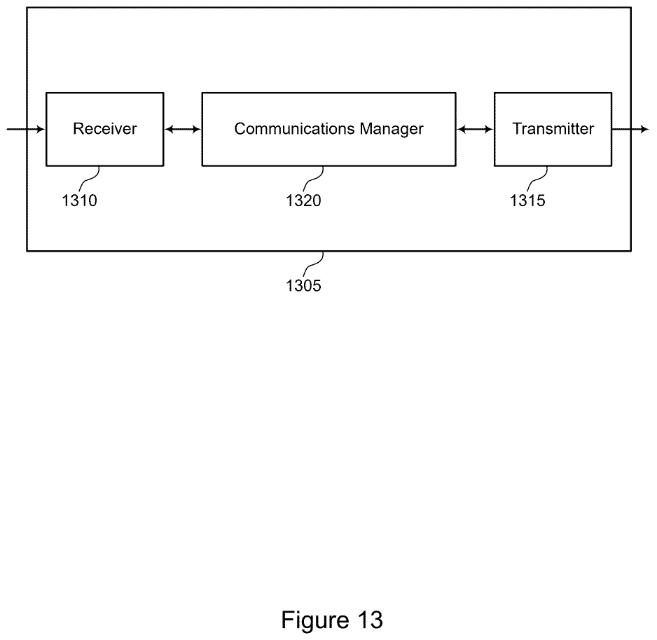

FIG. 13 shows a block diagram of a device 1305 that supports network-specific system information designs and signaling in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (for example, the receiver 1310, the transmitter 1315, the communications manager 1320), may include at least one processor, which may be coupled with at least one memory, to, individually or collectively, support or enable the described techniques. Each of these components may be in communication with one another (for example, via one or more buses).

The receiver 1310 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (for example, electrical, fiber optic) interfaces, wireless interfaces, or any combination thereof.

The transmitter 1315 may provide a means for outputting (for example, transmitting, providing, conveying, sending) information generated by other components of the device 1305. For example, the transmitter 1315 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (for example, electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of network-specific system information designs and signaling as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 1320, the receiver 1310, the transmitter 1315, or various combinations or components thereof may be implemented in code (for example, as communications management software or firmware) executed by at least one processor (for example, referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 1320 may be configured to perform various operations (for example, receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting a MIB indicating at least a set of SIBs, each SIB of the set of SIBs corresponding to a respective PLMN of a set of PLMNs supported by a first cell. The communications manager 1320 is capable of, configured to, or operable to support a means for transmitting the set of SIBs, a first SIB of the set of SIBs corresponding to a first PLMN of the set of PLMNs supported by a UE in accordance with transmitting the MIB. The communications manager 1320 is capable of, configured to, or operable to support a means for performing wireless communications via at least the first PLMN in accordance with the first SIB.

By including or configuring the communications manager 1320 in accordance with examples as described herein, the device 1305 (for example, at least one processor controlling or otherwise coupled with the receiver 1310, the transmitter 1315, the communications manager 1320, or a combination thereof) may support techniques for efficiently broadcasting PLMN-specific system information resulting in reduced processing by devices, reduced power consumption, more efficient utilization of communication resources, and improved user experience.

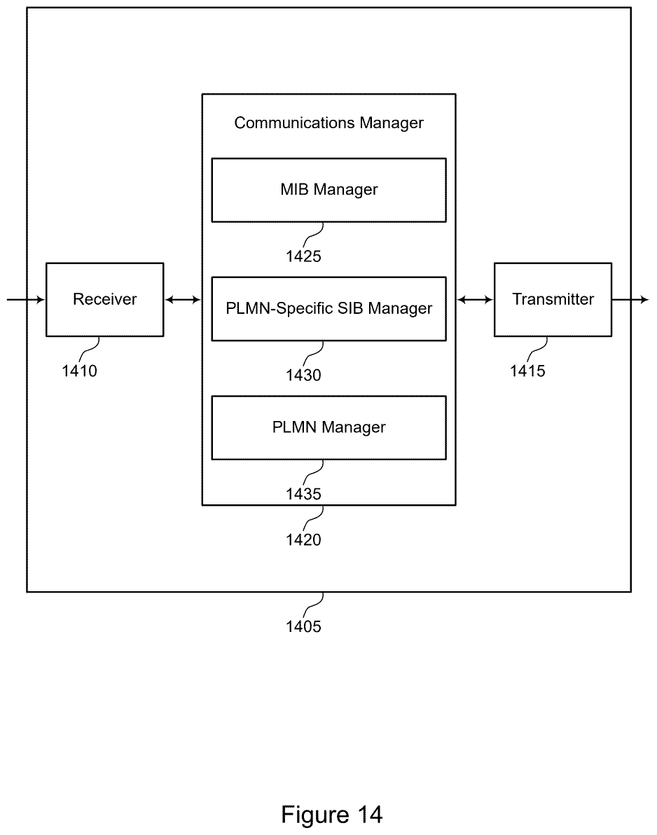

FIG. 14 shows a block diagram of a device 1405 that supports network-specific system information designs and signaling in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one of more components of the device 1405 (for example, the receiver 1410, the transmitter 1415, the communications manager 1420), may include at least one processor, which may be coupled with at least one memory, to support the described techniques. Each of these components may be in communication with one another (for example, via one or more buses).

The receiver 1410 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (for example, electrical, fiber optic) interfaces, wireless interfaces, or any combination thereof.

The transmitter 1415 may provide a means for outputting (for example, transmitting, providing, conveying, sending) information generated by other components of the device 1405. For example, the transmitter 1415 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (for example, electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of network-specific system information designs and signaling as described herein. For example, the communications manager 1420 may include a MIB manager 1425, an PLMN-specific SIB manager 1430, an PLMN manager 1435, or any combination thereof. In some examples, the communications manager 1420, or various components thereof, may be configured to perform various operations (for example, receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The MIB manager 1425 is capable of, configured to, or operable to support a means for transmitting a MIB indicating at least a set of SIBs, each SIB of the set of SIBs corresponding to a respective PLMN of a set of PLMNs supported by a first cell. The PLMN-specific SIB manager 1430 is capable of, configured to, or operable to support a means for transmitting the set of SIBs, a first SIB of the set of SIBs corresponding to a first PLMN of the set of PLMNs supported by a UE in accordance with transmitting the MIB. The PLMN manager 1435 is capable of, configured to, or operable to support a means for performing wireless communications via at least the first PLMN in accordance with the first SIB.

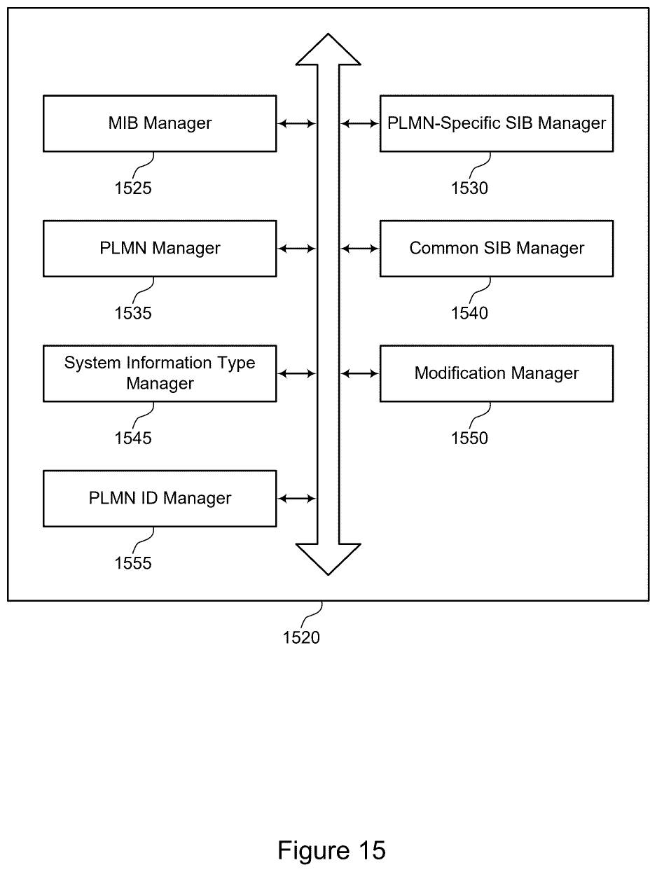

FIG. 15 shows a block diagram of a communications manager 1520 that supports network-specific system information designs and signaling in accordance with one or more aspects of the present disclosure. The communications manager 1520, or various components thereof, may be an example of means for performing various aspects of network-specific system information designs and signaling as described herein. For example, the communications manager 1520 may include a MIB manager 1525, an PLMN-specific SIB manager 1530, an PLMN manager 1535, a common SIB manager 1540, a system information type manager 1545, a modification manager 1550, an PLMN ID manager 1555, or any combination thereof. Each of these components, or components or subcomponents thereof (for example, one or more processors, one or more memories), may communicate, directly or indirectly, with one another (for example, via one or more buses). The communications may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The MIB manager 1525 is capable of, configured to, or operable to support a means for transmitting a MIB indicating at least a set of SIBs, each SIB of the set of SIBs corresponding to a respective PLMN of a set of PLMNs supported by a first cell. The PLMN-specific SIB manager 1530 is capable of, configured to, or operable to support a means for transmitting the set of SIBs, a first SIB of the set of SIBs corresponding to a first PLMN of the set of PLMNs supported by a UE in accordance with transmitting the MIB. The PLMN manager 1535 is capable of, configured to, or operable to support a means for performing wireless communications via at least the first PLMN in accordance with the first SIB.

In some examples, the first SIB includes a first PLMN identifier of the first PLMN, and a second SIB of the set of SIBs includes a second PLMN identifier of a second PLMN.

In some examples, the MIB further includes a set of multiple PLMN identifiers corresponding to respective PLMNs of the set of PLMNs, each PLMN identifier of the set of multiple PLMN identifiers mapped to a respective SIB of the set of SIBs.

In some examples, the common SIB manager 1540 is capable of, configured to, or operable to support a means for transmitting, in accordance with the MIB, a common SIB including a set of multiple PLMN identifiers corresponding to respective PLMNs of the set of PLMNs, each PLMN identifier of the set of multiple PLMN identifiers mapped to a respective SIB of the set of SIBs.

In some examples, the first SIB is a first common SIB, and where the first common SIB includes an indication of one or more additional SIBs corresponding to the first PLMN, and a list of PLMN identifiers corresponding to the set of PLMNs, and where a second common SIB includes an indication of one or more additional SIBs corresponding to a second PLMN, and the list of PLMN identifiers corresponding to the set of PLMNs.

In some examples, the system information type manager 1545 is capable of, configured to, or operable to support a means for transmitting an indication of a first type of system information corresponding to at least one PLMN of the set of PLMNs, and of a second type of system information corresponding to a second set of PLMNs, where the second set of PLMNs do not correspond to the set of SIBs.

In some examples, the modification manager 1550 is capable of, configured to, or operable to support a means for transmitting an indication of a P-RNTI corresponding to the first PLMN. In some examples, the modification manager 1550 is capable of, configured to, or operable to support a means for transmitting system information modification signaling for the first PLMN in accordance with the P-RNTI.

In some examples, the PLMN ID manager 1555 is capable of, configured to, or operable to support a means for receiving a request message including a first PLMN identifier corresponding to the first PLMN, the request message indicating a request for the first SIB that is specific to the first PLMN, where transmitting the first SIB in accordance with receiving the request message.

In some examples, the PLMN-specific SIB manager 1530 is capable of, configured to, or operable to support a means for receiving, by a DU of the network entity from a centralized unit (CU), an indication of the first SIB corresponding to the first PLMN, where transmitting the first SIB is in accordance with receiving the indication.

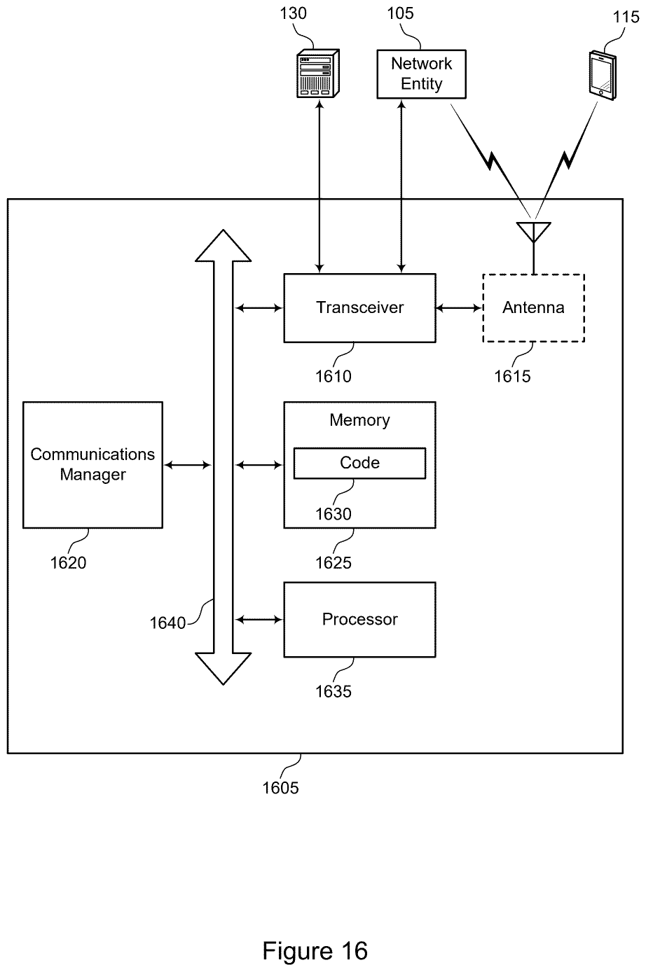

FIG. 16 shows a diagram of a system including a device 1605 that supports network-specific system information designs and signaling in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (for example, operatively, communicatively, functionally, electronically, electrically) via one or more buses (for example, a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (for example, concurrently). The transceiver 1610 may also include a modem to modulate signals, to provide the modulated signals for transmission (for example, by one or more antennas 1615, by a wired transmitter), to receive modulated signals (for example, from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (for example, the at least one processor 1635, the at least one memory 1625, or both), may be included in a chip or chip assembly that is installed in the device 1605. In some examples, the transceiver 1610 may be operable to support communications via one or more communications links (for example, communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (for example, when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (for example, one or more of the at least one memory 1625) to cause the device 1605 to perform various functions (for example, functions or tasks supporting network-specific system information designs and signaling). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (for example, one or more physical nodes and supporting software such as operating systems, virtual machines, or container instances) that may host the functions (for example, by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (for example, within) a protocol layer of a protocol stack. In some examples, a bus 1640 may support communications associated with a logical channel of a protocol stack (for example, between protocol layers of a protocol stack), which may include communications performed within a component of the device 1605, or between different components of the device 1605 that may be co-located or located in different locations (for example, where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (for example, via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (for example, in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting a MIB indicating at least a set of SIBs, each SIB of the set of SIBs corresponding to a respective PLMN of a set of PLMNs supported by a first cell. The communications manager 1620 is capable of, configured to, or operable to support a means for transmitting the set of SIBs, a first SIB of the set of SIBs corresponding to a first PLMN of the set of PLMNs supported by a UE in accordance with transmitting the MIB. The communications manager 1620 is capable of, configured to, or operable to support a means for performing wireless communications via at least the first PLMN in accordance with the first SIB.

By including or configuring the communications manager 1620 in accordance with examples as described herein, the device 1605 may support techniques for efficiently broadcasting PLMN-specific system information resulting in reduced processing by devices, reduced power consumption, more efficient utilization of communication resources, more efficient utilization of communication resources, improved coordination between devices, decreased system latency, increased throughput, and improved user experience.

In some examples, the communications manager 1620 may be configured to perform various operations (for example, receiving, obtaining, monitoring, outputting, transmitting) using or otherwise in cooperation with the transceiver 1610, the one or more antennas 1615 (for example, where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of network-specific system information designs and signaling as described herein, or the at least one processor 1635 and the at least one memory 1625 may be otherwise configured to, individually or collectively, perform or support such operations.

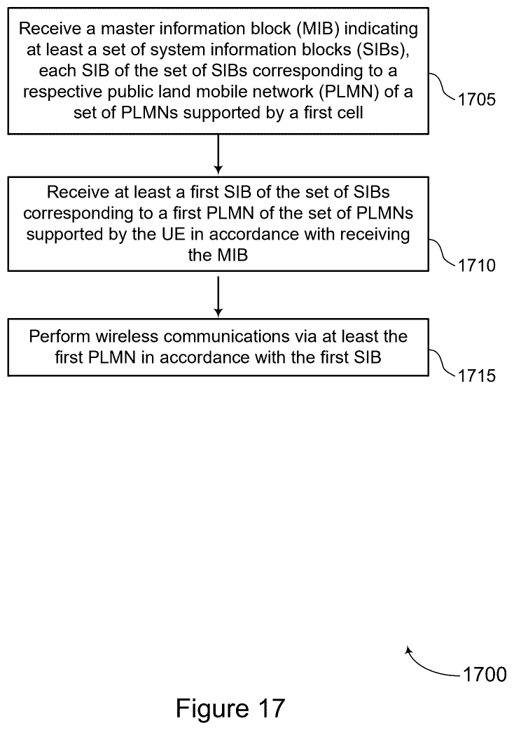

FIG. 17 shows a flowchart illustrating a method 1700 that supports network-specific system information designs and signaling in accordance with one or more aspects of the present disclosure. The operations of the method 1700 may be implemented by a UE or its components as described herein. For example, the operations of the method 1700 may be performed by a UE 115 as described with reference to FIGS. 1-12. In some examples, a UE may execute a set of instructions to control the functional elements of the UE to perform the described functions. Additionally, or alternatively, the UE may perform aspects of the described functions using special-purpose hardware.

At 1705, the method may include receiving a MIB indicating at least a set of SIBs, each SIB of the set of SIBs corresponding to a respective PLMN of a set of PLMNs supported by a first cell. The operations of 1705 may be performed in accordance with examples as disclosed herein. In some examples, aspects of the operations of 1705 may be performed by a MIB manager 1125 as described with reference to FIG. 11.

At 1710, the method may include receiving at least a first SIB of the set of SIBs corresponding to a first PLMN of the set of PLMNs supported by the UE in accordance with receiving the MIB. The operations of 1710 may be performed in accordance with examples as disclosed herein. In some examples, aspects of the operations of 1710 may be performed by an PLMN-specific SIB manager 1130 as described with reference to FIG. 11.

At 1715, the method may include performing wireless communications via at least the first PLMN in accordance with the first SIB. The operations of 1715 may be performed in accordance with examples as disclosed herein. In some examples, aspects of the operations of 1715 may be performed by an PLMN manager 1135 as described with reference to FIG. 11.

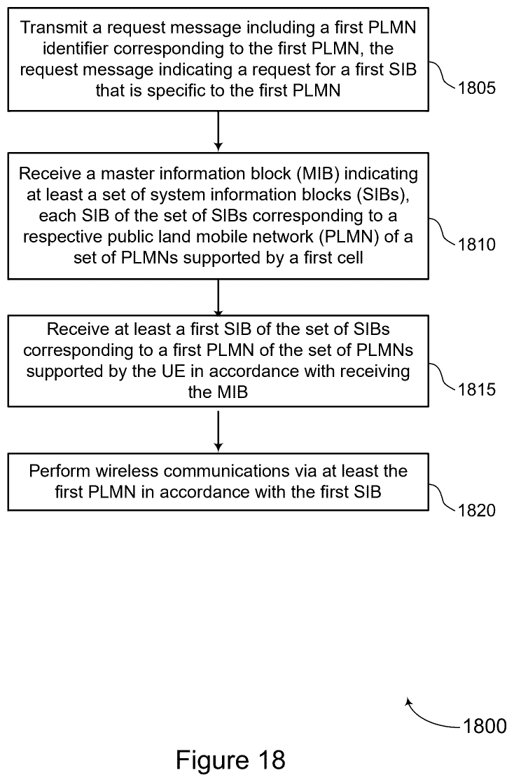

FIG. 18 shows a flowchart illustrating a method 1800 that supports network-specific system information designs and signaling in accordance with one or more aspects of the present disclosure. The operations of the method 1800 may be implemented by a UE or its components as described herein. For example, the operations of the method 1800 may be performed by a UE 115 as described with reference to FIGS. 1-12. In some examples, a UE may execute a set of instructions to control the functional elements of the UE to perform the described functions. Additionally, or alternatively, the UE may perform aspects of the described functions using special-purpose hardware.

At 1805, the method may include transmitting a request message including a first PLMN identifier corresponding to the first PLMN, the request message indicating a request for a first SIB that is specific to the first PLMN. The operations of 1805 may be performed in accordance with examples as disclosed herein. In some examples, aspects of the operations of 1805 may be performed by an PLMN ID manager 1160 as described with reference to FIG. 11.

At 1810, the method may include receiving a MIB indicating at least a set of SIBs, each SIB of the set of SIBs corresponding to a respective PLMN of a set of PLMNs supported by a first cell. The operations of 1810 may be performed in accordance with examples as disclosed herein. In some examples, aspects of the operations of 1810 may be performed by a MIB manager 1125 as described with reference to FIG. 11.

At 1815, the method may include receiving at least a first SIB of the set of SIBs corresponding to a first PLMN of the set of PLMNs supported by the UE in accordance with receiving the MIB. The operations of 1815 may be performed in accordance with examples as disclosed herein. In some examples, aspects of the operations of 1815 may be performed by an PLMN-specific SIB manager 1130 as described with reference to FIG. 11.

At 1820, the method may include performing wireless communications via at least the first PLMN in accordance with the first SIB. The operations of 1820 may be performed in accordance with examples as disclosed herein. In some examples, aspects of the operations of 1820 may be performed by an PLMN manager 1135 as described with reference to FIG. 11.

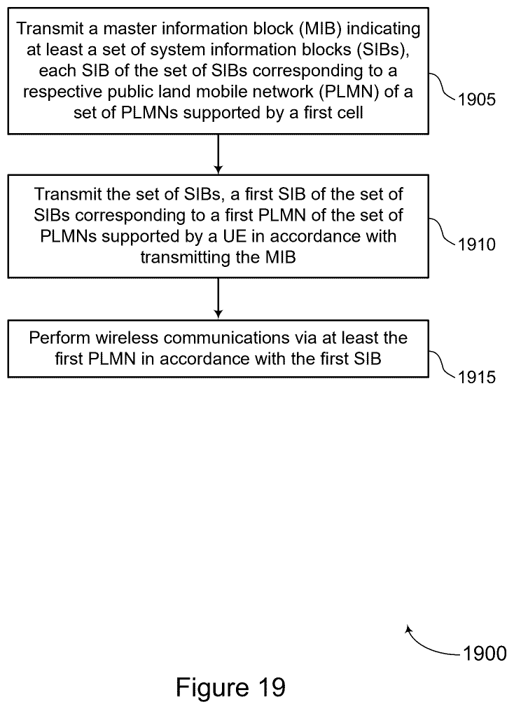

FIG. 19 shows a flowchart illustrating a method 1900 that supports network-specific system information designs and signaling in accordance with one or more aspects of the present disclosure. The operations of the method 1900 may be implemented by a network entity or its components as described herein. For example, the operations of the method 1900 may be performed by a network entity as described with reference to FIGS. 1-8 and 13-16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a MIB indicating at least a set of SIBs, each SIB of the set of SIBs corresponding to a respective PLMN of a set of PLMNs supported by a first cell. The operations of 1905 may be performed in accordance with examples as disclosed herein. In some examples, aspects of the operations of 1905 may be performed by a MIB manager 1525 as described with reference to FIG. 15.

At 1910, the method may include transmitting the set of SIBs, a first SIB of the set of SIBs corresponding to a first PLMN of the set of PLMNs supported by a UE in accordance with transmitting the MIB. The operations of 1910 may be performed in accordance with examples as disclosed herein. In some examples, aspects of the operations of 1910 may be performed by an PLMN-specific SIB manager 1530 as described with reference to FIG. 15.

At 1915, the method may include performing wireless communications via at least the first PLMN in accordance with the first SIB. The operations of 1915 may be performed in accordance with examples as disclosed herein. In some examples, aspects of the operations of 1915 may be performed by an PLMN manager 1535 as described with reference to FIG. 15.

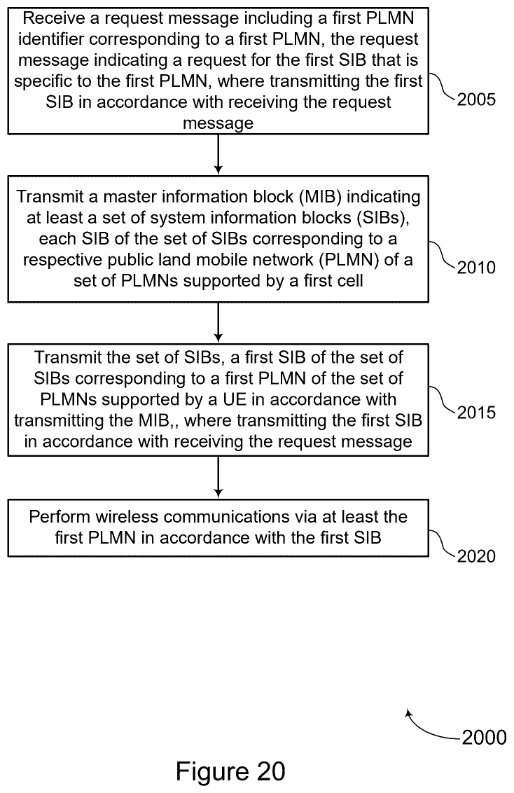

FIG. 20 shows a flowchart illustrating a method 2000 that supports network-specific system information designs and signaling in accordance with one or more aspects of the present disclosure. The operations of the method 2000 may be implemented by a network entity or its components as described herein. For example, the operations of the method 2000 may be performed by a network entity as described with reference to FIGS. 1-8 and 13-16. In some examples, a network entity may execute a set of instructions to control the functional elements of the network entity to perform the described functions. Additionally, or alternatively, the network entity may perform aspects of the described functions using special-purpose hardware.

At 2005, the method may include receiving a request message including a first PLMN identifier corresponding to a first PLMN, the request message indicating a request for a first SIB that is specific to the first PLMN. The operations of 2005 may be performed in accordance with examples as disclosed herein. In some examples, aspects of the operations of 2005 may be performed by an PLMN ID manager 1555 as described with reference to FIG. 15.

At 2010, the method may include transmitting a MIB indicating at least a set of SIBs, each SIB of the set of SIBs corresponding to a respective PLMN of a set of PLMNs supported by a first cell. The operations of 2010 may be performed in accordance with examples as disclosed herein. In some examples, aspects of the operations of 2010 may be performed by a MIB manager 1525 as described with reference to FIG. 15.

At 2015, the method may include transmitting the set of SIBs, a first SIB of the set of SIBs corresponding to a first PLMN of the set of PLMNs supported by a UE in accordance with transmitting the MIB, where transmitting the first SIB is in accordance with receiving the request message. The operations of 2015 may be performed in accordance with examples as disclosed herein. In some examples, aspects of the operations of 2015 may be performed by an PLMN-specific SIB manager 1530 as described with reference to FIG. 15.

At 2020, the method may include performing wireless communications via at least the first PLMN in accordance with the first SIB. The operations of 2020 may be performed in accordance with examples as disclosed herein. In some examples, aspects of the operations of 2020 may be performed by an PLMN manager 1535 as described with reference to FIG. 15.

The following provides an overview of aspects of the present disclosure:
Aspect 1: A method for wireless communications at a UE, comprising: receiving a MIB indicating at least a set of SIBs, each SIB of the set of SIBs corresponding to a respective PLMN of a set of PLMNs supported by a first cell; receiving at least a first SIB of the set of SIBs corresponding to a first PLMN of the set of PLMNs supported by the UE in accordance with receiving the MIB; and performing wireless communications via at least the first PLMN in accordance with the first SIB.
Aspect 2: The method of aspect 1, wherein the first SIB includes a first PLMN identifier of the first PLMN, wherein receiving the first SIB of the set of SIBs is in accordance with reading the first PLMN identifier.
Aspect 3: The method of aspect 2, further comprising: refraining from receiving at least a second SIB of the set of SIBs corresponding to a second PLMN in accordance with the first SIB including the first PLMN identifier, wherein the UE does not support the second PLMN.
Aspect 4: The method of any of aspects 1 through 3, wherein the MIB further comprises a plurality of PLMN identifiers corresponding to respective PLMNs of the set of PLMNs, each PLMN identifier of the plurality of PLMN identifiers corresponding to a respective SIB of the set of SIBs in accordance with a mapping.
Aspect 5: The method of any of aspects 1 through 4, further comprising: receiving, in accordance with the MIB, a common SIB comprising a plurality of PLMN identifiers corresponding to respective PLMNs of the set of PLMNs, each PLMN identifier of the plurality of PLMN identifiers corresponding to a respective SIB of the set of SIBs in accordance with a mapping.
Aspect 6: The method of any of aspects 1 through 5, wherein the first SIB is a common SIB, and wherein the first SIB includes an indication of one or more additional SIBs corresponding to the first PLMN, and a list of PLMN identifiers corresponding to the set of PLMNs and wherein performing the wireless communications via the first PLMN is in accordance with the first SIB and additional system information corresponding to one or more additional SIBs in accordance with the first SIB.
Aspect 7: The method of any of aspects 1 through 6, further comprising: receiving a first common SIB in accordance with receiving the MIB, the first common SIB including system information corresponding to a second PLMN, an indication of one or more additional SIBs corresponding to the second PLMN, and a list of PLMN identifiers corresponding to the set of PLMNs; monitoring for at least a second common SIB in accordance with the first common SIB and the list of PLMN identifiers comprising a first PLMN identifier corresponding to the first PLMN wherein the second common SIB is the first SIB, the first SIB including an indication of one or more additional SIBs corresponding to the first PLMN, and the list of PLMN identifiers corresponding to the set of PLMNs; and receiving the one or more additional SIBs in accordance with the first SIB, the one or more additional SIBs including additional system information for the first PLMN, wherein performing the wireless communications via the first PLMN is in accordance with the first SIB and the additional system information.
Aspect 8: The method of any of aspects 1 through 7, further comprising: receiving an indication of a first type of system information corresponding to at least one PLMN of the set of PLMNs, and of a second type of system information corresponding to a second set of PLMNs, wherein the second set of PLMNs do not correspond to the set of SIBs.
Aspect 9: The method of any of aspects 1 through 8, further comprising: receiving an indication of a P-RNTI corresponding to the first PLMN; and monitoring for system information modification signaling for the first PLMN in accordance with the P-RNTI.
Aspect 10: The method of any of aspects 1 through 9, further comprising: transmitting a request message comprising a first PLMN identifier corresponding to the first PLMN, the request message indicating a request for the first SIB that is specific to the first PLMN.
Aspect 11: A method for wireless communications at a network entity, comprising: transmitting a MIB indicating at least a set of SIBs, each SIB of the set of SIBs corresponding to a respective PLMN of a set of PLMNs supported by a first cell; transmitting the set of SIBs, a first SIB of the set of SIBs corresponding to a first PLMN of the set of PLMNs supported by a UE in accordance with transmitting the MIB; and performing wireless communications via at least the first PLMN in accordance with the first SIB.
Aspect 12: The method of aspect 11, wherein the first SIB includes a first PLMN identifier of the first PLMN, and a second SIB of the set of SIBs includes a second PLMN identifier of a second PLMN.
Aspect 13: The method of any of aspects 11 through 12, wherein the MIB further comprises a plurality of PLMN identifiers corresponding to respective PLMNs of the set of PLMNs, each PLMN identifier of the plurality of PLMN identifiers mapped to a respective SIB of the set of SIBs.
Aspect 14: The method of any of aspects 11 through 13, further comprising: transmitting, in accordance with the MIB, a common SIB comprising a plurality of PLMN identifiers corresponding to respective PLMNs of the set of PLMNs, each PLMN identifier of the plurality of PLMN identifiers mapped to a respective SIB of the set of SIBs.
Aspect 15: The method of any of aspects 11 through 14, wherein the first SIB is a first common SIB, and wherein the first common SIB includes an indication of one or more additional SIBs corresponding to the first PLMN, and a list of PLMN identifiers corresponding to the set of PLMNs, and wherein a second common SIB includes an indication of one or more additional SIBs corresponding to a second PLMN, and the list of PLMN identifiers corresponding to the set of PLMNs.
Aspect 16: The method of any of aspects 11 through 15, further comprising: transmitting an indication of a first type of system information corresponding to at least one PLMN of the set of PLMNs, and of a second type of system information corresponding to a second set of PLMNs, wherein the second set of PLMNs do not correspond to the set of SIBs.
Aspect 17: The method of any of aspects 11 through 16, further comprising: transmitting an indication of a P-RNTI corresponding to the first PLMN; and transmitting system information medication signaling for the first PLMN in accordance with the P-RNTI.
Aspect 18: The method of any of aspects 11 through 17, further comprising: receiving a request message comprising a first PLMN identifier corresponding to the first PLMN, the request message indicating a request for the first SIB that is specific to the first PLMN, wherein transmitting the first SIB in accordance with receiving the request message.
Aspect 19: The method of any of aspects 11 through 18, further comprising: receiving, by a DU of the network entity from a CU, an indication of the first SIB corresponding to the first PLMN, wherein transmitting the first SIB is in accordance with receiving the indication.
Aspect 20: A UE for wireless communications, comprising one or more memories storing processor-executable code, and one or more processors coupled with the one or more memories and individually or collectively operable to execute the code to cause the UE to perform a method of any of aspects 1 through 10.
Aspect 21: A UE for wireless communications, comprising at least one means for performing a method of any of aspects 1 through 10.
Aspect 22: A non-transitory computer-readable medium storing code for wireless communications, the code comprising instructions executable by one or more processors to perform a method of any of aspects 1 through 10.
Aspect 23: A network entity for wireless communications, comprising one or more memories storing processor-executable code, and one or more processors coupled with the one or more memories and individually or collectively operable to execute the code to cause the network entity to perform a method of any of aspects 11 through 19.
Aspect 24: A network entity for wireless communications, comprising at least one means for performing a method of any of aspects 11 through 19.
Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (for example, receiving information), accessing (for example, accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a master information block (MIB) indicating at least a set of system information blocks (SIBs), each SIB of the set of SIBs corresponding to a respective public land mobile network (PLMN) of a set of PLMNs supported by a first cell;
receive at least a first SIB of the set of SIBs corresponding to a first PLMN of the set of PLMNs supported by the UE in accordance with receiving the MIB; and
perform wireless communications via at least the first PLMN in accordance with the first SIB.

2. The UE of claim 1, wherein the first SIB includes a first PLMN identifier of the first PLMN, wherein receiving the first SIB of the set of SIBs is in accordance with reading the first PLMN identifier.

3. The UE of claim 2, wherein the processing system is further configured to cause the UE to refrain from receiving at least a second SIB of the set of SIBs corresponding to a second PLMN in accordance with the first SIB including the first PLMN identifier, wherein the UE does not support the second PLMN.

4. The UE of claim 1, wherein the MIB further comprises a plurality of PLMN identifiers corresponding to respective PLMNs of the set of PLMNs, each PLMN identifier of the plurality of PLMN identifiers corresponding to a respective SIB of the set of SIBs in accordance with a mapping.

5. The UE of claim 1, wherein the processing system is further configured to cause the UE to receive, in accordance with the MIB, a common SIB comprising a plurality of PLMN identifiers corresponding to respective PLMNs of the set of PLMNs, each PLMN identifier of the plurality of PLMN identifiers corresponding to a respective SIB of the set of SIBs in accordance with a mapping.

6. The UE of claim 1, wherein the first SIB is a common SIB, wherein the first SIB includes an indication of one or more additional SIBs corresponding to the first PLMN, and a list of PLMN identifiers corresponding to the set of PLMNs, and wherein performing the wireless communications via the first PLMN is in accordance with the first SIB and additional system information corresponding to one or more additional SIBs in accordance with the first SIB.

7. The UE of claim 1, wherein the processing system is further configured to cause the UE to:
receive a first common SIB in accordance with receiving the MIB, the first common SIB including system information corresponding to a second PLMN, an indication of one or more additional SIBs corresponding to the second PLMN, and a list of PLMN identifiers corresponding to the set of PLMNs;
monitor for at least a second common SIB in accordance with the first common SIB and the list of PLMN identifiers comprising a first PLMN identifier corresponding to the first PLMN wherein the second common SIB is the first SIB, the first SIB including an indication of one or more additional SIBs corresponding to the first PLMN, and the list of PLMN identifiers corresponding to the set of PLMNs; and
receive the one or more additional SIBs in accordance with the first SIB, the one or more additional SIBs including additional system information for the first PLMN, wherein performing the wireless communications via the first PLMN is in accordance with the first SIB and the additional system information.

8. The UE of claim 1, wherein the processing system is further configured to cause the UE to receive an indication of a first type of system information corresponding to at least one PLMN of the set of PLMNs, and of a second type of system information corresponding to a second set of PLMNs, wherein the second set of PLMNs do not correspond to the set of SIBs.

9. The UE of claim 1, wherein the processing system is further configured to cause the UE to:
receive an indication of a paging radio network temporary identifier (P-RNTI) corresponding to the first PLMN; and
monitor for system information modification signaling for the first PLMN in accordance with the P-RNTI.

10. The UE of claim 1, wherein the processing system is further configured to cause the UE to transmit a request message comprising a first PLMN identifier corresponding to the first PLMN, the request message indicating a request for the first SIB that is specific to the first PLMN.

11. A network entity, comprising:
a processing system that includes processor circuitry and memory circuitry that stores code, the processing system configured to cause the network entity to:
transmit a master information block (MIB) indicating at least a set of system information blocks (SIBs), each SIB of the set of SIBs corresponding to a respective public land mobile network (PLMN) of a set of PLMNs supported by a first cell;
transmit the set of SIBs, a first SIB of the set of SIBs corresponding to a first PLMN of the set of PLMNs supported by a user equipment (UE) in accordance with transmitting the MIB; and
perform wireless communications via at least the first PLMN in accordance with the first SIB.

12. The network entity of claim 11, wherein the first SIB includes a first PLMN identifier of the first PLMN, and a second SIB of the set of SIBs includes a second PLMN identifier of a second PLMN.

13. The network entity of claim 11, wherein the MIB further comprises a plurality of PLMN identifiers corresponding to respective PLMNs of the set of PLMNs, each PLMN identifier of the plurality of PLMN identifiers mapped to a respective SIB of the set of SIBs.

14. The network entity of claim 11, wherein the processing system is further configured to cause the UE to transmit, in accordance with the MIB, a common SIB comprising a plurality of PLMN identifiers corresponding to respective PLMNs of the set of PLMNs, each PLMN identifier of the plurality of PLMN identifiers mapped to a respective SIB of the set of SIBs.

15. The network entity of claim 11, wherein the first SIB is a first common SIB, and wherein the first common SIB includes an indication of one or more additional SIBs corresponding to the first PLMN, and a list of PLMN identifiers corresponding to the set of PLMNs, and wherein a second common SIB includes an indication of one or more additional SIBs corresponding to a second PLMN, and the list of PLMN identifiers corresponding to the set of PLMNs.

16. The network entity of claim 11, wherein the processing system is further configured to cause the UE to transmit an indication of a first type of system information corresponding to at least one PLMN of the set of PLMNs, and of a second type of system information corresponding to a second set of PLMNs, wherein the second set of PLMNs do not correspond to the set of SIBs.

17. The network entity of claim 11, wherein the processing system is further configured to cause the UE to:
transmit an indication of a paging radio network temporary identifier (P-RNTI) corresponding to the first PLMN; and
transmit system information modification signaling for the first PLMN in accordance with the P-RNTI.

18. The network entity of claim 11, wherein the processing system is further configured to cause the UE to receive a request message comprising a first PLMN identifier corresponding to the first PLMN, the request message indicating a request for the first SIB that is specific to the first PLMN, wherein transmitting the first SIB in accordance with receiving the request message.

19. The network entity of claim 11, wherein the processing system is further configured to cause the UE to receive, by a distributed unit (DU) of the network entity from a centralized unit (CU), an indication of the first SIB corresponding to the first PLMN, wherein transmitting the first SIB is in accordance with receiving the indication.

20. A method for wireless communications by a user equipment (UE), comprising:
receiving a master information block (MIB) indicating at least a set of system information blocks (SIBs), each SIB of the set of SIBs corresponding to a respective public land mobile network (PLMN) of a set of PLMNs supported by a first cell;
receiving at least a first SIB of the set of SIBs corresponding to a first PLMN of the set of PLMNs supported by the UE in accordance with receiving the MIB; and
performing wireless communications via at least the first PLMN in accordance with the first SIB.

21. The method of claim 20, wherein the first SIB includes a first PLMN identifier of the first PLMN, wherein receiving the first SIB of the set of SIBs is in accordance with reading the first PLMN identifier.

22. The method of claim 21, further comprising refraining from receiving at least a second SIB of the set of SIBs corresponding to a second PLMN in accordance with the first SIB including the first PLMN identifier, wherein the UE does not support the second PLMN.

23. The method of claim 20, wherein the MIB further comprises a plurality of PLMN identifiers corresponding to respective PLMNs of the set of PLMNs, each PLMN identifier of the plurality of PLMN identifiers corresponding to a respective SIB of the set of SIBs in accordance with a mapping.

24. The method of claim 20, further comprising receiving, in accordance with the MIB, a common SIB comprising a plurality of PLMN identifiers corresponding to respective PLMNs of the set of PLMNs, each PLMN identifier of the plurality of PLMN identifiers corresponding to a respective SIB of the set of SIBs in accordance with a mapping.

25. The method of claim 20, wherein the first SIB is a common SIB, and wherein the first SIB includes an indication of one or more additional SIBs corresponding to the first PLMN, and a list of PLMN identifiers corresponding to the set of PLMNs and wherein performing the wireless communications via the first PLMN is in accordance with the first SIB and additional system information corresponding to one or more additional SIBs in accordance with the first SIB.

26. The method of claim 20, further comprising:
receiving a first common SIB in accordance with receiving the MIB, the first common SIB including system information corresponding to a second PLMN, an indication of one or more additional SIBs corresponding to the second PLMN, and a list of PLMN identifiers corresponding to the set of PLMNs;
monitoring for at least a second common SIB in accordance with the first common SIB and the list of PLMN identifiers comprising a first PLMN identifier corresponding to the first PLMN wherein the second common SIB is the first SIB, the first SIB including an indication of one or more additional SIBs corresponding to the first PLMN, and the list of PLMN identifiers corresponding to the set of PLMNs; and
receiving the one or more additional SIBs in accordance with the first SIB, the one or more additional SIBs including additional system information for the first PLMN, wherein performing the wireless communications via the first PLMN is in accordance with the first SIB and the additional system information.

27. The method of claim 20, further comprising receiving an indication of a first type of system information corresponding to at least one PLMN of the set of PLMNs, and of a second type of system information corresponding to a second set of PLMNs, wherein the second set of PLMNs do not correspond to the set of SIBs.

28. The method of claim 20, further comprising:
receiving an indication of a paging radio network temporary identifier (P-RNTI) corresponding to the first PLMN; and
monitoring for system information modification signaling for the first PLMN in accordance with the P-RNTI.

29. The method of claim 20, further comprising transmitting a request message comprising a first PLMN identifier corresponding to the first PLMN, the request message indicating a request for the first SIB that is specific to the first PLMN.

30. A method for wireless communications by a network entity, comprising:
transmitting a master information block (MIB) indicating at least a set of system information blocks (SIBs), each SIB of the set of SIBs corresponding to a respective public land mobile network (PLMN) of a set of PLMNs supported by a first cell;
transmitting the set of SIBs, a first SIB of the set of SIBs corresponding to a first PLMN of the set of PLMNs supported by a user equipment (UE) in accordance with transmitting the MIB; and
performing wireless communications via at least the first PLMN in accordance with the first SIB.
